(19) United States
(12) Patent Application Publication
(10) Pub. No.: US 2018/0107979 A1
(43) Pub. Date: Apr. 19, 2018

(54) COMPUTER-IMPLEMENTED METHOD, COMPUTER PROGRAM PRODUCT, AND SYSTEM FOR FACILITATING ON-DEMAND REMOTE SHOPPING

(71) Applicants: Brant Westover, Eagle Mountain, UT (US); Bryson Westover, Eagle Mountain, UT (US)

(72) Inventors: Brant Westover, Eagle Mountain, UT (US); Bryson Westover, Eagle Mountain, UT (US)

(21) Appl. No.: 15/783,995

(22) Filed: Oct. 13, 2017

Related U.S. Application Data
(60) Provisional application No. 62/408,637, filed on Oct. 14, 2016.

(51) Int. Cl. G06Q 10/08; G06Q 30/06; H04L 12/58

(52) U.S. Cl. CPC G06Q 10/08355; G06Q 30/0611; G06Q 50/01; H04L 51/20; H04L 51/04

(57) ABSTRACT

A computer program product, system, and computer-implemented method for brokering an online transaction between a consumer and a provider of a consumer good. The method includes creation of an item request, an acceptance of the item request by one or more providers and/or consumers, and accepting a delivery confirmation of a consumer good into computer-readable memory. Consumers and providers may be matched together using a matching algorithm. An available pool of providers is determined to perform a requested delivery based at least in part on proximity of the delivery location of the consumer to the final destination of the provider, and the given time range. The available pool of providers may be adjusted to include only providers satisfying a consumer selection criteria.

### BACKGROUND OF THE INVENTION

### Field of the Invention

This invention relates generally to on-demand mobile phone applications, and more specifically relates to mobile-device connected shopping network applications (also known as “apps”) for smartphones.

### Description of the Related Art

Simple on-demand product/service networks accessible by users via mobile devices are known in the art. Typically, these on-demand network systems connect consumers and providers for a wide variety of goods and services such as transportation and restaurant order/delivery services. Consumers or users in these on-demand networks register for access to the network's offered goods and services which are delivered when the user places an order by an available provider.

Current network structure and methodology often pose risks, inefficiencies and limitations to the users. For example, risks to the user can come in the form of unknown information regarding those providing or delivering the goods and services. The user is generally reliant on the networks vetting process of the providers to ensure not only proper delivery of the goods and services, but also for the user's own personal safety and well-being.

Additionally, a user's ability to acquire goods and services through an on-demand network is generally limited to the goods and services offered by the network. If the user desires goods or services not offered by the network, then the user has to find another network offering those goods and services. Moreover, the goods and services offered through a network are often for specific brands associated with the network which additionally limits the consumer's ability to window shop, price compare, and price match competing brands.

Other complications with typical on-demand networks are often found in the pricing and payment methods used which generally require considerable coordination between the network, the user, and the provider for both agreed-upon prices and also acceptable methods of payment.

### SUMMARY OF THE INVENTION

From the foregoing discussion, it should be apparent that a need exists for a computer program product, method and system for facilitating on-demand remote shopping. Beneficially, such an on-demand network would allow consumers to create consumer/item requests which a provider would be willing to supply, allowing a consumer to window shop virtually while engaging in real-time communication with the provider. Additional benefit can be realized by a payment methodology centrally controlled by the on-demand network wherein the user and provider establish accounts directly through the on-demand network to finance the procurement and delivery of the ordered goods and services.

The present invention has been developed in response to the problems and needs in the art that have not yet been fully solved by currently available apparati and methods. Accordingly, the present invention has been developed to provide a computer-implemented method for brokering a real world transaction, the steps of the method comprising: accepting into computer-readable memory on a signal bearing medium geolocation information of a plurality of consumers and a plurality of providers; accepting into computer-readable memory a delivery location from each of the plurality of consumers, the delivery location exclusively associated with a consumer; accepting into computer-readable memory from each of the plurality of providers, a final destination, a provider's route of travel, and radius parameters around the route of travel; wherein the final destination, the route of travel, and the radius parameters are exclusively associated with the provider; accepting into computer-readable memory a shopping location from one or more of: a plurality of consumers and a plurality of providers; identifying a group of consumers whose accepted delivery locations which are enveloped by the radius parameters around the route of travel; identifying a group of providers exclusively associated with routes of travel that envelope one or more accepted delivery locations of the plurality of consumers; relaying the identified group of consumers to one or more providers; relaying the identified group of providers to one or more consumers; facilitating real-time bi-directional textual communication exclusively between a consumer whose delivery location is enveloped by radius parameters exclusively associated with a provider's route of travel and the provider exclusively associated with the radius parameters; accepting into computer-readable memory an item request originating with a consumer, the item request comprising a name of a consumer good; relaying to the provider within real-time textual communication with the consumer an item request originating with the consumer; recording into computer-readable memory a provider response to the item request, the provider response comprising an integer indicative of a price of the consumer good; recording into computer-readable memory a consumer acceptance of the provider response; relaying to the provider a Boolean value evaluating as true in response to consumer acceptance of the provider response; and receiving and storing into computer-readable memory a delivery confirmation originating with the consumer in response to a provider delivering the consumer good.

The method may further comprise eliminating providers from the group of providers who fail to satisfy a consumer selection criterion.

The consumer selection criterion may be satisfied upon reference to historical data exclusively associated with the provider in persistent computer-readable memory establishing: average delivery time of consumer goods for the provider is within a predetermined interval of time; the provider is associated on social media with more than a predetermined number of contacts of the consumer; the provider has less than a predetermined threshold of negative reports from consumers; and a geolocation of the provider is at a location preference of the consumer.

The consumer selection criterion may also comprise one or more of: reaching a threshold of on time deliveries; reaching a threshold of completed deliveries; reaching a response threshold to real-time communication attempts of previous consumers; and being within a preferred location.

The method may further comprise: organizing the providers into one of the following abstract data types into computer-readable memory: a stack, a queue, an associative array; and graphically displaying those providers in the abstract data type on a GUI who satisfy a plurality of consumer selection criteria.

The method may further comprise: displaying a plurality of providers at a specified geolocation; and accepting into computer-readable memory a selection from a consumer of one of the plurality of providers.

The facilitating of real time textual communication may further comprise displaying a virtual field in which an item request is identified by the consumer using one of: a character string manually created on a touch display; and a drop-down virtual menu; and wherein the item request is added to a computer-readable file comprising the consumer request in an RDBMS.

In various embodiments, the consumer good comprises one of a perishable food, a digital media, an item of clothing, an appliance, and an electronic device.

The step of facilitating real-time textual communication may further comprise: displaying a history of textual communications between the consumer and the provider; receiving into computer-readable memory from the consumer an item request; relaying the name of the item request to the provider; relaying the digital media of the item request to the consumer; receiving into computer-readable memory a price in the form of a integer set by the provider for the item request; and accepting an uploaded Boolean value from the consumer representing acceptance or rejection of the price set by the provider.

The method may further comprise: receiving from the provider a digital media over a signal-bearing medium, the digital medium comprising an image of the item request; and receiving from the provider a digital media comprising an image of a receipt for purchase of the item request.

The method may further comprise facilitating real-time video communication between the provider and the consumer originating the item request, the real-time video communication commenced in response to the consumer selecting the provider's acceptance of the consumer request.

The method may further comprise facilitating real-time textual communication between the consumer and a plurality of providers having accepted consumer requests, the real-time video communication commenced in response to the consumer receiving a plurality of acceptances from the plurality of providers.

The method may also comprise: adding a flat rate tip value to the price of a sum of all prices relayed to the consumer by the provider, the flat rate tip value predetermined by a third-party without input from the consumer and provider; and preventing the consumer and provider from augmenting or reducing a remuneration total predetermined by the remuneration criteria.

In various embodiments, the method further comprises accepting a first transmitted acceptance by a provider of the consumer request by enqueuing a Boolean consisting of an acceptance of the provider and by enqueuing a name of the provider in a queue in the computer-readable memory.

The method may also further comprise matching the consumer with a provider, the steps of matching the consumer with a provider comprising: storing into computer-readable memory names and addresses of a plurality of preferred retailers, the names and addresses of the plurality of preferred retailers originating with the consumer; storing in computer-readable memory a radius value, the radius value comprising a radius from a retail location within which a provider will deliver a consumer product; determining a distance between the consumer and the retail location by passing parameters to an API, the parameters comprising: geolocation information of the consumer and the address of a preferred retailer; and relaying the name of the provider to the consumer in response to determining that the distance is less than the radius value.

The API may comprise one of the Google Maps Geocoding API™ and Google Maps Direction API™. The method may further comprise matching the consumer with a provider, the steps of matching the consumer with a provider comprising: storing in computer-readable memory a time maximum, the time maximum comprising a maximum delivery time from a retail location to the consumer within which a provider will deliver a consumer product; determining a travel time between the consumer and the retail location by passing parameters to an API, the parameters comprising: GPS coordinates of the delivery address and GPS coordinates of the retail location; and relaying the name of the provider to the consumer in response to determining that the travel time is less than the time maximum.

A computer program product comprising a signal bearing computer-readable medium having computer-usable program code executable for brokering a real world transaction is also provided, the operations of the computer program product comprising: accepting a geolocation of a consumer and a provider; storing a consumer request from a consumer, the consumer request comprising a name of a consumer good; identifying a group of consumers within a predetermined polygonal area surrounding the geolocation of a provider who is available for purchasing a consumer good and who is associated with the consumer via social media; relaying each of the consumer requests to the group of providers; storing the name of a provider accepting the consumer request to the consumer; facilitating real-time textual communication between the consumer and the provider picked by the consumer, wherein the real-time textual communication further comprises: displaying a history of textual communications between the consumer and the provider; accepting an item request by a consumer, the item request added to a computer-readable file with the consumer request in an RDBMS; relaying the name of the item request to the provider via a WAN; relaying the media to the consumer; storing and forwarding a price set by the provider for the item request; and accepting an uploaded Boolean value from the consumer representing acceptance or rejection of the price set by the provider; accepting a delivery confirmation from the consumer in response to the provider delivering the consumer good; and remunerating the provider picked by the consumer in accordance with a predetermined remuneration criteria.

The consumer request may comprise one or more of: a delivery cut off time, and a geolocation of the consumer, and a delivery address. Facilitating real-time textual communication may further comprise: receiving into computer-readable memory, via the WAN, from the provider media comprising an image of a consumer good identified in the item request in response to a consumer requesting the media; and relaying the media to the consumer.

The executable computer usable program code may form part of an operating system on a smartphone written in one of C++, C* and assembly language.

The computer program product may further comprise: adding a flat rate tip value to the price of the sum of the consumer good and one or more item requests, the flat rate tip value predetermined by a third-party without input from the consumer and provider; preventing the consumer and provider from augmenting or reducing a remuneration total predetermined by the remuneration criteria.

The computer program product may further comprise relaying a push notification to the consumer from the provider in response to the provider being geolocated within a predetermined distance of a target location.

A system for brokering a real world transaction is also provided, the system comprising: a plurality of processors; persistent computer-readable memory; a location module configured to determine a geolocation of a plurality of providers expressed in GPS coordinates and one or more of the following: GPS coordinates of a consumer expressed in standard global positioning system (GPS) coordinates; a physical address of a consumer expressed as a mailing address in a character string; a geocoding module configured to: convert GPS coordinates to a mailing address in a character string; and convert a character string comprising as mailing address to GPS coordinates; a storer module configured to store an item request originating with a consumer, the item request comprising a name of a consumer good, a name of a shopping location, and a delivery location specified by the consumer; a provider incorporator module configured to identify a group of consumers within a polygonal area surrounding a shifting dynamic location of a provider who are available for purchasing a consumer good and who satisfy a social media criterion; a request creator module configured to store and relay each of the consumer requests to the group of providers; a facilitator module configured to facilitate real-time textual communication exclusively between a consumer and a provider; and a determiner module configured to store a Boolean delivery confirmation value in computer-readable memory from the consumer in response to the provider delivering the consumer good.

Each of the modules may be embodied by computer usable program code coded in the form on an object imparting function to each of the modules.

The system may further comprise an eliminator module configured to eliminate a provider originating a consumer request, wherein the consumer selection criteria comprises a Boolean value evaluating as true in response to previous occurrence of one or more of the following events: recent consumer complaints; non-delivery of a consumer product in an earlier item request originating with another consumer; late delivery of a consumer product in an earlier item request originating with another consumer; non-delivery of a consumer product in an earlier item request originating with the consumer; late delivery of a consumer product in an earlier item request originating with the consumer; non-delivery of a consumer product in an earlier item request originating with another consumer; and damage to a consumer product in an earlier item request.

A consumer preference criteria may be satisfied with respect to providers being located by the location module within a predetermined geographic radius of the consumer.

The system may further comprise a matcher module configured to match an item request with a provider having a highest match satisfaction value with a match selection criterion, the match satisfaction value being derived as a function of one or more of the following values: a value determined by totaling the number of social contact the consumer and a provider share in common; a provider determined by the location module to be within a shortest predetermined distance from the consumer; a total number of previous confirmed deliveries of a provider; and a provider's positive ratings stored in computer-readable memory.

In various embodiments, the system further comprises a matcher module configured to match the consumer with a provider, the matcher module comprising a plurality of submodules, the submodules comprising: a retailer module configured to store in computer-readable memory names and addresses of a plurality of preferred retailers, the names and addresses of the plurality of preferred retailers identified by the consumer; a distance module configured to accept and store in computer-readable memory one of: a radius value, the radius value comprising a radius from a retail location within which a provider will deliver a consumer product; and a time maximum, the time maximum comprising a maximum delivery time from a retail location to the consumer within which a provider will deliver a consumer product; a determiner module configured to do one or more of the following: determine a distance between the consumer and the retail location by passing parameters to an API, the parameters comprising: geolocation information of the consumer and the address of a preferred retailer; and determine a travel time between the consumer and the retail location by passing parameters to an API, the parameters comprising: geolocation information of the consumer and the address of a preferred retailer; a notification module configured to relay the name of the provider to the consumer in response to determining one or more of: the distance is less than the radius value and the travel time is less than the time maximum.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is block diagram of a system for brokering real-world transactions in accordance with an embodiment of the present invention;

FIG. 2A is flow chart of a method used by the system of FIG. 1 to broker real-world transactions;

FIG. 2B is flow chart of a method used by the system of FIG. 1 to broker real-world transactions;

FIG. 3 is user interface displayed to a user in accordance with the present invention;

FIG. 4 is user interface displayed to a user in accordance with the present invention;

FIG. 5 is user interface displayed to a user in accordance with the present invention;

FIG. 6A is user interface displayed to a user in accordance with the present invention;

FIG. 6B is user interface displayed to a user in accordance with the present invention;

FIG. 7 is user interface displayed to a user in accordance with the present invention;

FIG. 8 is user interface displayed to a user in accordance with the present invention;

FIG. 9 is an entity-relationship diagram illustrating data flow between entities in accordance with the present invention;

FIG. 10 is an entity-relationship diagram illustrating data flow between entities in accordance with the present invention;

FIG. 11A is a block diagram illustrating modules of a system in accordance with the present invention;

FIG. 11B is a block diagram illustrating a matcher module of a system in accordance with the present invention;

FIG. 11C is a data layout diagram illustrating provider historical data in accordance with the present invention;

FIG. 12A is an entity-relationship diagram illustrating modules of a system in accordance with the present invention;

FIG. 12B is an entity-relationship diagram illustrating modules of a system in accordance with the present invention;

FIG. 12C is an entity-relationship diagram illustrating modules of a system in accordance with the present invention;

FIG. 13 is a data layout diagram illustrating one embodiment of an item request in accordance with the present invention;

FIG. 14A is a data-entity diagram illustrating a method of matching a provider and consumer in accordance with the present invention;

FIG. 14B is a data-entity diagram illustrating a method of matching a provider and consumer in accordance with the present invention;

FIG. 14C is a data-entity diagram illustrating a method of matching a provider and consumer in accordance with the present invention;

FIG. 14D is a data-entity diagram illustrating a method of matching a provider and consumer in accordance with the present invention;

FIG. 15 is a flow chart illustrating the steps of a method of matching a provider and consumer in accordance with the present invention;

FIG. 16 is a flow chart illustrating the steps of a method of matching a provider and consumer in accordance with the present invention;

FIG. 17 is a flow chart illustrating the steps of a method of matching a provider and consumer in accordance with the present invention;

FIG. 18 is a flow chart illustrating the steps of a method of matching a provider and consumer in accordance with the present invention;

FIG. 19 is a flow chart illustrating the steps of a method of matching a provider and consumer in accordance with the present invention; and

FIG. 20 is a flow chart illustrating the steps of a method of matching a provider and consumer in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are given to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The embodiments of the present invention described herein generally provide for a system, computer program product, and a method for using an online network to facilitate remote shopping by interconnecting consumers with providers who are willing to provide a desired good(s). Those individuals and entities desiring or needing a consumer good are referred to herein as consumers, shoppers or requesters and these terms are used synonymously throughout this specification. Similarly individuals or organizations who are willing to provide the desired goods and services are herein referred to as runners or providers and these terms are used synonymously throughout this specification. Reference to consumers or providers may include a tablet computer, smartphone, or DPD (data processing device) under the control of the consumer or provider. Additionally, the community described herein may be referred to as a network, group, friends, or family and these terms are synonymous as used throughout this specification. Consumers and providers may also be referred to collectively hereinafter as users. The technology provider may be a DPD or system of DPDs, including server(s), operating independently of the consumers and providers, configured to facilitate the receipt, maintenance and provision of information between the consumers and providers.

Hence, in general terms, the present invention provides for an online network that can broker a transaction between a consumer who is at one location with a provider who is at another location and is willing to purchase, pickup, and deliver goods and services from the provider's location, or a location near the provider's location, to the requester's or consumer's location. For example, if one individual in an online network is at home, and notices, via the online network, that a friend is at a grocery store, then the first individual (the consumer) can use the online network to signal the friend (the provider) at the store and request the friend to pick up a product from the store and deliver it to the individual's home. In this example, the first individual is a shopper, requester, or consumer, and the friend is a runner or provider.

Determining to match the requester and provider can be a function of the provider's chosen radius around the route to the provider's final destination. If a delivery location of the consumer falls within a geographic area defined by the radius around a projected travel route, the requester and provider may be matched.

In other embodiments, the consumer and provider are matched if the final destination on the provider's route of travel (or projected delivery path as further described below) is within a predetermined geographical distance of the delivery location of the requester or a predetermined polygonal area. The system, computer program product (CPP) and method can examine the delivery locations of consumers, and the final destinations of providers, and determine any possible matches between members of the network. Alternatively the system, CPP and method can examine the delivery locations of consumers and determine whether said delivery locations are within specified, or predetermined, geographic areas assigned by a provider representing distances the provider is willing to deviate from a projected delivery path.

Consumers may be matched with providers with whom they are not acquainted using algorithms and processes further described below.

The method also adjusts the possible matches based on criteria selected by the consumers and the providers, such as whether the consumer and provider are friends or otherwise approved connections within the network, or if the provider is willing or able to seek out special requirements of the consumer. Once the possible matches are adjusted to the approved criteria, the system, computer program product (CPP) and method can transmit the approved matches to the requesters and providers along with possible communication tools to enable the requesters and providers to negotiate any specific details of the transaction. With the details of the transaction determined and agreed upon between the requester/consumer and runner/provider, the system, CPP and method allows the requester and provider to track the transaction until final delivery. The system, CPP, and method can record successful deliveries and may allow the consumer and provider to rate one another's performance in the transaction. The method tracks transaction ratings for users, and displays the ratings in future transactions as information that can help the parties in a transaction.

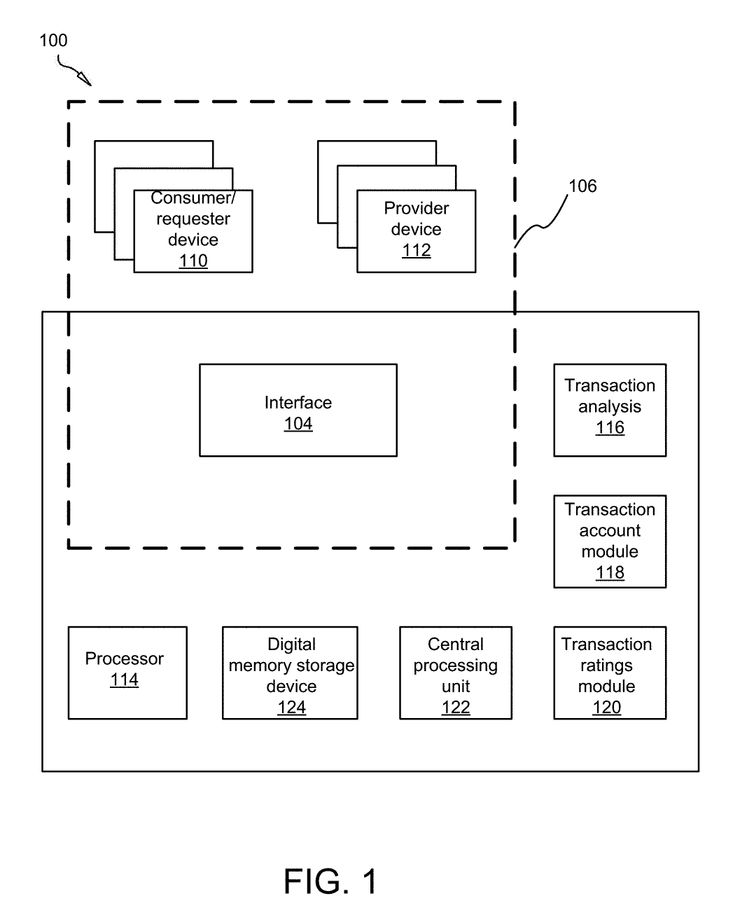

Accordingly, as illustrated in FIG. 1, a real world transaction brokering system, indicated generally at 100, is shown in accordance with an embodiment of the present invention for brokering real world transactions in a virtual environment such as an online network between a requester and a provider of goods and services. The system 100 is shown and described broadly in FIG. 1. The system 100 can receive real time data from requesters/consumers and providers for a given request for goods and services, and can analyze the real time data along with previously stored data to match transactions between requesters with providers based on delivery locations of requesters, the projected delivery path of a provider, and final destinations of providers. The system 100 can also adjust the transaction matches based on previously stored preference data from requesters and providers. In this way, the system 100 can dynamically modify transaction matches to correlate with user preferences regarding not only which provider is available for delivery but which provider is preferred for delivery.

The system 100 can include an interface, indicated generally at 104, for interacting with requester and provider devices, indicated generally at 110 and 112, respectively. In one aspect the interface 104 can include a network, indicated generally at 106, that can be established between the requester and provider devices 110 and 112.

The system 100 can also include a processor, indicated generally at 114, that can receive, process, analyze, manipulate, store, and transmit data between the requester and provider devices 110 and 112. For example, the processor 114 can include a transaction analysis module, indicated generally at 116, that can receive request data for goods and services from a requester device 110 and can compare and analyze the requester data against data previously received from possible providers to find a transaction match between the requester data and provider data. The transaction match data can then be transmitted by the processor 114 to the requester and provider devices 110 and 112. The processor 114 can also have a transaction account module, indicated generally at 118, that can store and process transaction accounting data to track and manage payments between requesters and providers. Additionally, the processor 114 can have a transaction ratings module, indicated generally at 120, that can store and process ratings data of requesters and providers which can be used by requesters and providers in making decisions on which possible transactions to accept.

In this way, the system 100 may include one or more processors 114 that execute instructions on a computer-readable medium, such as a central processing unit, indicated generally at 122, or digital memory storage device 124, that cause the one or more processors 114 to make a determination of desired delivery locations of requesters for a service in a given time range. The processor 114 can then make a determination as to whether prospective delivery destinations of a provider are within a given time range and/or a specified (or predetermined geographic area) as defined by said provider, and determine an available pool of providers to perform a requested delivery based at least in part on proximity of the delivery location of the requester within the projected delivery path of the provider, and within the given time range. The processor 114 can then adjust the available pool of providers to include only providers previously approved by a consumer/requester. The processor 114 can then transmit available provider data corresponding to the adjusted available pool of providers to one or more requesting devices 110 or one or more provider devices 112 so that the adjusted pool of available providers can be displayed on at least one or more requesting devices 110.

In one aspect, the system 100 can also include a plurality of mobile computing devices, such as requester devices 110 and provider devices 112, that can be capable of generating GPS location data. In this case, a requester's GPS location data can be correlated with a provider's GPS location data such that the processor 114 can determine a transaction match between a requester and a provider using the GPS location data.

In another aspect, the one or more processors 114 can include programming to make a determination of the delivery locations based on data received from the one or more requesting devices 110. In this case, the data can include information about current conditions relating to a request for goods or services to be delivered or performed at the delivery location and corresponding to conditions such as a requesting device launching an application used for requesting the provider service, a requesting device requesting the provider service using the application, a requesting device closing the application, a current location of a requesting device, a destination location requested by a requesting device, a route requested by a requesting device, and the like.

In yet another aspect, the one or more processors 114 can include programming to make a determination of available providers based on provider data that is received from the one or more provider devices 114. In this case, the provider data can include an availability of a provider, a current state of a location of a provider device, a final destination of a provider, a route traveled by a provider from a current location to a final destination, a determination of whether a prospective delivery destination is within a predetermined geographic area or within a predetermined radius of a projected delivery route, and the like.

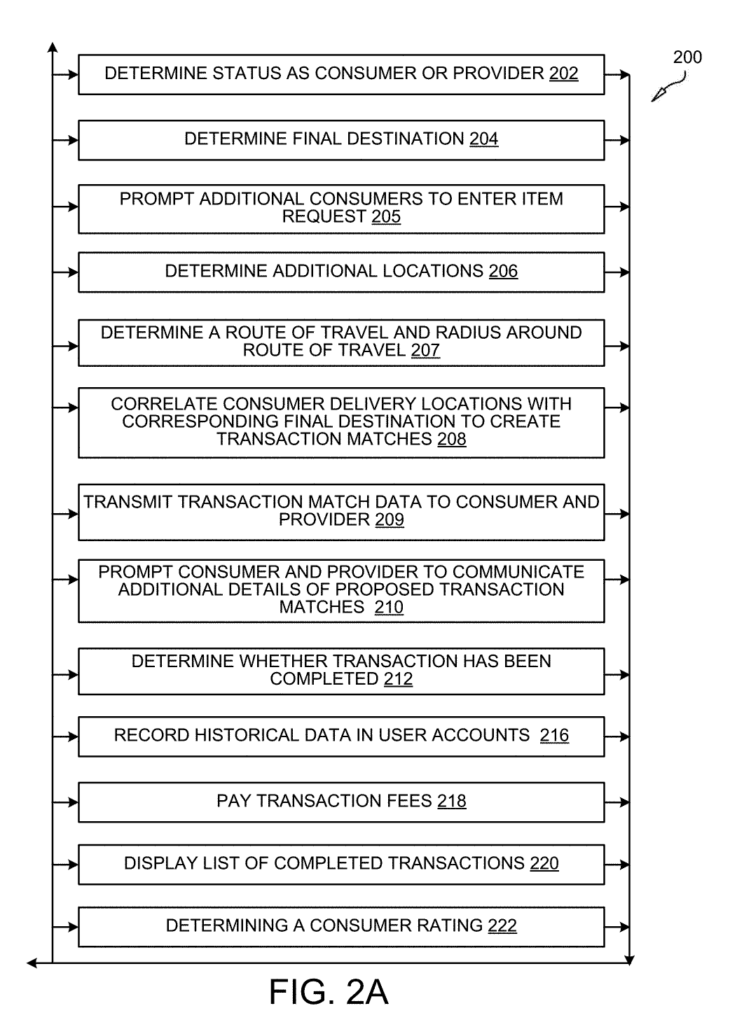

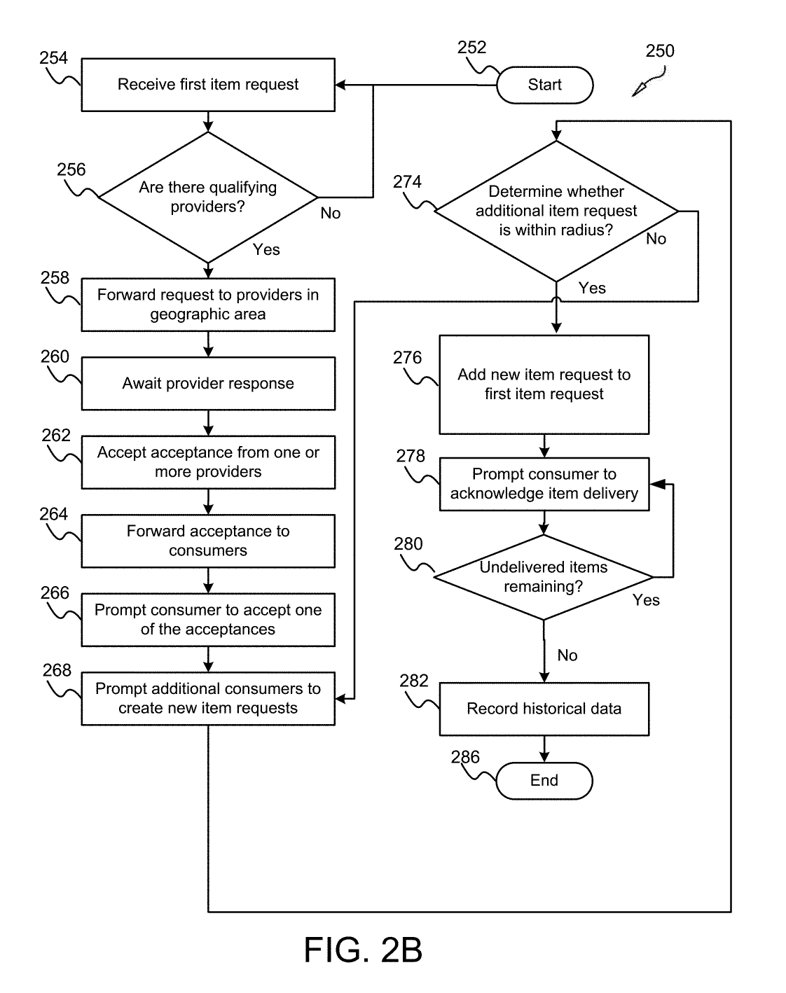

FIG. 2 illustrates a method for brokering a real-world transaction, indicated generally at 200, and is shown in accordance with an embodiment of the present invention for connecting a requester to a provider from within a community. The method can be performed by one or more computer processors (as shown at 114 in FIG. 1) as found in internet servers, desktop computers, and mobile devices.

The method 200 includes determining from input from a user whether the user is a consumer or a provider, as shown at 202. Input from a user may also be used to determine a delivery location if the user is a consumer, or a final destination within a projected delivery route if the user is a provider, as shown at 204.

In various embodiments, additional consumers may be prompted 205 to create new item requests (or consumer requests). New item requests may comprise new computer files or data types or alternatively may be added to an item request already existing between the consumer and the provider. In other embodiments, the consumers who have not yet been connected with a provider are prompted 205 to create item requests which may be matched with a provider already acting to realize or fulfill delivery pursuant to a previously created item request.

If a provider is matched with a consumer creating an item request, using means further explained in relation to figures below, additional delivery locations 206 falling or determined 207 to be within a predetermined radius of the provider's final destination and/or a predetermined radius surrounding the provider's projected route of travel, may be added to an existing item request, or otherwise determined 206 to be associated with a provider. In some embodiments, a single item request is stored in computer-readable memory as a readable-file while in other embodiments, multiple item requests are correlated or exclusively associated with a provider. Multiple item requests exclusively associated with said provider may be organized within a larger scheduling file and/or may be sorted and stored in an RDBMS.

Consumer delivery locations can be correlated, by the one or more processors and/or technology provider, with corresponding delivery locations to create transaction matches between consumers and providers, as shown at 208. Transaction match data can be transmitted via the one or more processors to consumer and provider devices, shown at 209. An online communication tool can be provided to allow consumers and providers to communicate additional details of a proposed transaction matches including acceptance or rejection of the transaction match by the consumer and provider, shown at 210. The one or more processors can use input from the user to determine whether the transaction has been completed, shown at 212, and delivery can be recorded in a user account, shown at 216, with a consumer account being charged a transaction fee and a provider account being paid the transaction fee, as shown at 218. The transaction fees may be paid from a general account under the control of the technology provider to a provider delivering the consumer good.

The method 200 can also include determining from input from users a pool of approved transaction partners. Transaction match data can then be correlated with the pool of approved transaction partners. The transaction match data can then be adjusted to include only matches between approved transaction partners, and the adjusted transaction match data can be transmitted to the consumer and provider devices.

The method 200 can also allow a user, either consumer or provider, to approve possible transaction partners from transaction matches that are not already approved transaction partners. In this way, as the processor analysis yields possible transaction matches that do not meet all of a user's preferences, the user, whether requester or provider, can in a real-time manner authorize a transaction match in order to allow the processor to record the transaction. Advantageously, this real-time authorization provides greater flexibility to the users who can adjust the transaction matches to include possible matches outside the preference parameters which the processor uses to parse the possible match data.

It will be appreciated that other data besides prospective delivery destination proximity and authorized approval of a provider can be used to adjust the potential transaction match data. For example, the method 200 can also determine from user input a consumer's preference for a particular product type, brand, or price. Then based on provider input the method can determine whether a possible provider has the ability to procure the consumer's preferred product type and brand. The method can then correlate the consumer preference data with data from the potential provider's ability to meet the consumer's request in order to determine a transaction match.

Similarly, the method 200 can also be used to determine, based on user input, a consumer's preference for shopping location. Then, based on a provider's input, the method can determine the provider's ability to shop at the consumer's preferred shopping location. The consumer preference shopping data can then be correlated with the provider ability data to determine a transaction match between a consumer that wants something from a particular store and a provider who is near that particular store and will be able to deliver the desired product to the consumer based on the above and below described geographic matching criteria.

The method also provides for determining 222 a consumer rating for consumer users and a provider rating for provider users. The ratings can be generated by user input data with consumers rating providers and providers rating consumers on a sliding quality scale. The consumer and provider ratings can be transmitted with the transaction match data (or consumer request) to the consumer and/or to the provider to provide the transaction parties with past performance quality data regarding the potential transaction matches.

It is a particular advantage that the method 200 also provides for allowing a provider to combine more than one transaction from more than one consumer at a time. Thus, the method 200 provides for determining from user input a plurality of transaction matches for a provider each of which are within a projected delivery path to the provider's final destination. This allows the provider to accept more than one transaction match at a time so as to increase the transaction fees paid into the provider's transaction account.

Consumers may also communicate directly with providers using either communication tools provided by the method application software, such as instant messaging or chat features and protocols, or by communication means external to the transaction broker method 200 such as email, telephonic conversation, texting, and the like. Regardless of the method used, details of the transaction can be fine-tuned or chosen regarding various shopping and product options that might be available at the provider's location. In this way, the consumer can conduct price and brand comparisons and provide real-time data to the provider while the provider communicates product information back to the consumer.

In various embodiments, a list of completed transactions may be displayed 220 to a consumer and/or provider, limited to those transactions in which the consumer or provider has participated.

Providers who fail to timely or properly deliver consumer goods may be ranked by consumers whom the providers are servicing. These consumers may choose to exclude negatively-rated providers from future acceptance to new consumer requests. The rankings (or ratings) of providers may be facilitated and/or viewable by a user wall (or social wall).

FIG. 2B is flow chart of a method 250 used by the system of FIG. 1 to broker real-world transactions in accordance with the present invention.

A consumer request is received 254 into computer-readable memory over a signal bearing medium. The consumer request is further described below, but comprises a computer file, or a series of computer files, identifying a consumer with whom the request originated and a consumer good the consumer would like purchased and delivered.

In various embodiments, the CPP, system, or method performs a check 256 to determine whether or not there are qualified providers, who satisfy a relevant consumer selection criteria (further described below).

In response to there being qualified providers, the method 250 progresses and the consumer request is forwarded 258 to providers. In some embodiments, providers are given a predetermined period of time within which to respond, during which time the technology provider awaits 260 provider response.

An acceptance from one or more providers is then accepted 262 and written into computer-readable memory. The acceptance may be transmitted from a wireless DPD over a WAN (wide area network) (and may comprise a simple variable such as a Boolean evaluated as true if the provider has accepted) to a computer-readable file in a DBMS with parameters or conditions of the provider acceptance.

The acceptance is forwarded 264 from computer-readable memory to the consumer with whom the consumer request originated. In various embodiments, only the first acceptance is accepted by the technology provider. In other embodiments, a plurality of acceptances are accepted and forwarded 264 to the consumer, who is prompted 266 to select or accept one of the acceptances from a provider or plurality of providers.

In various embodiments, the consumer or other consumers are then prompted 268 to create new item requests. If 274 a delivery location associated with the new item requests (expressed either as a physical address or using GPS coordinates) falls within a predetermined radius of either the delivery address associated with the first item request or within a predetermined radius of a route of travel plotted by the technology provider to said delivery address, the new item request may be associated with the provider and the provider obligated to fulfill delivery of the good(s) defined by the new item request by adding 276 the new item request to a delivery queue in one embodiments (or alternatively to the first item request in other embodiments).

Consumers are prompted 278 to confirm delivery of each good associated with an item request until there are no undelivered items remaining, or undelivered items have been given an undeliverable status or unknown status by the technology provider. If 280 undelivered items whose status remains undelivered persist, the method 250 returns to 278.

Historical data, including the delivery status of all goods, is recorded 282 in computer-readable memory.

At this point in the method 250, real-time communication between the consumer and the provider may begin as further described below. Alternatively, the consumer may be prompted to await 268 confirmation that the provider has purchased an item, then the technology provider may await confirmation from the consumer that the consumer good or item has been delivered by the provider. A rating from the consumer of the provider may then be accepted and written into computer-readable memory.

If the provider has been favorably ranked, reviewed or rated by the consumer, then the provider may be given priority with respect to future consumer requests. Alternatively stated, the provider may then satisfy, or have a higher degree of satisfaction with, a consumer selection criteria established by a consumer with respect to a future consumer request.

If the provider continues to perform, the provider's satisfaction continues to increase and is recorded in memory.

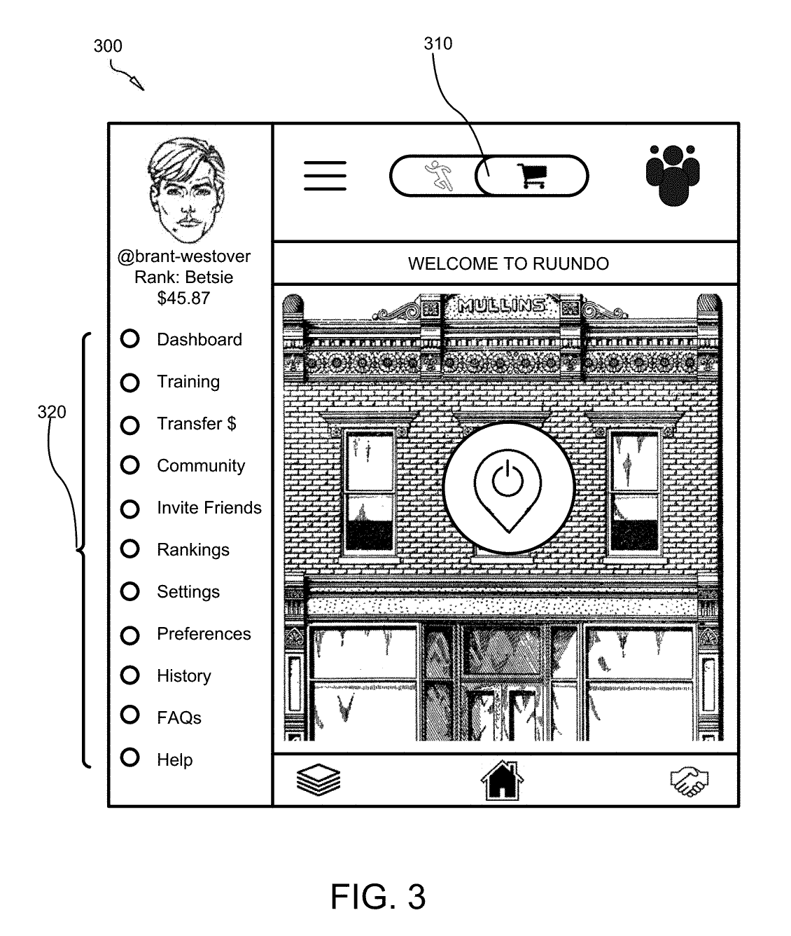

FIGS. 3-8 illustrate a series of user interfaces that can be displayed to users in either a consumer role or a provider role in accordance with the present invention. The user interfaces show various functional features that can be provided in the system 100 and methods 200 described herein. For example, FIG. 3 shows one embodiment of an application page, indicated generally at 300, on which a user can select from many options, indicated generally at 320, to navigate around the system interface. A switch 310 can be activated to allow the user to choose between being a consumer or a provider before any given transaction.

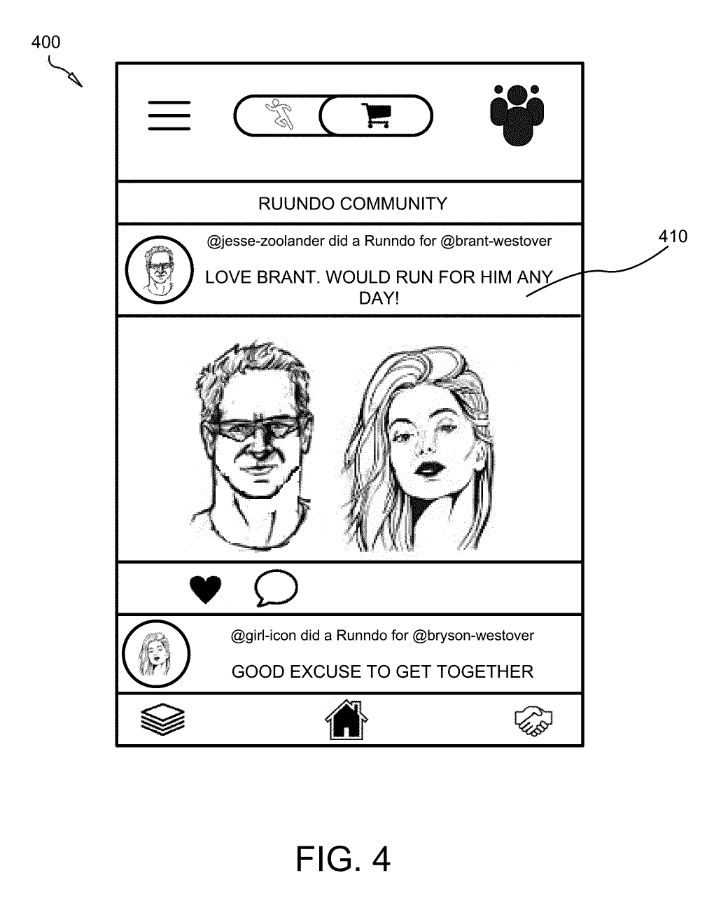

FIG. 4 shows a community news feed page, indicated generally at 400, that acts like a news feed wall on many common social network sites. In this case of the embodiments described herein, the news feed page is used to record and publish information 410 about upcoming, ongoing, or recent past transactions using the system 100.

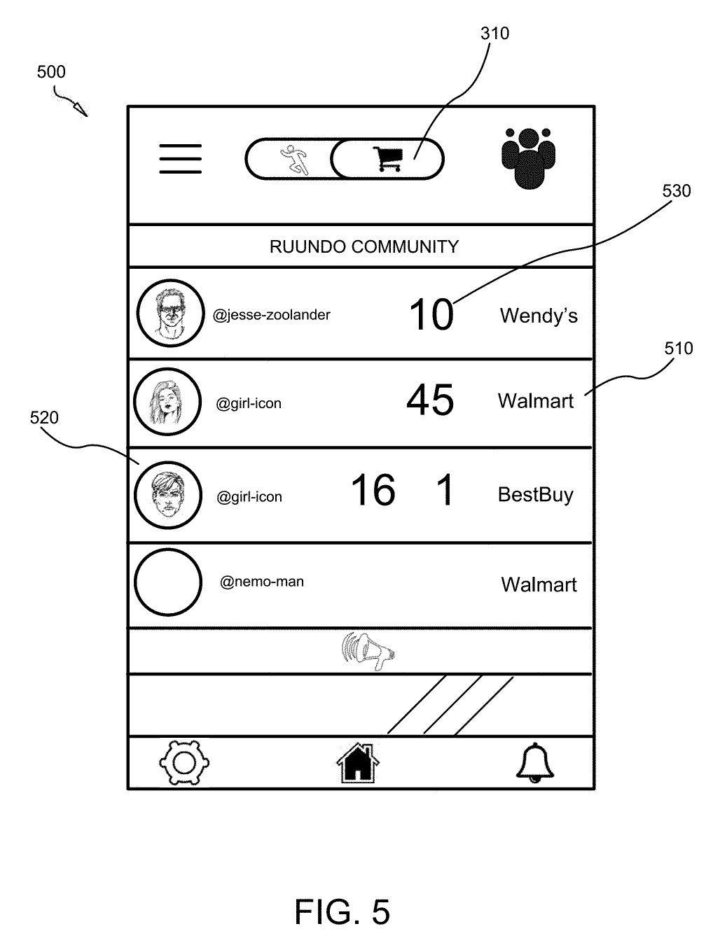

FIG. 5 shows a window shopping page as viewed by a consumer, indicated generally at 500, that can display all available shopping/item requests and also available runners when the switch 310 is in the runner/provider position. The page can show information about the shopping/item request such as desired location of purchase 510, information about the user 520, and time window that provider is available 530.

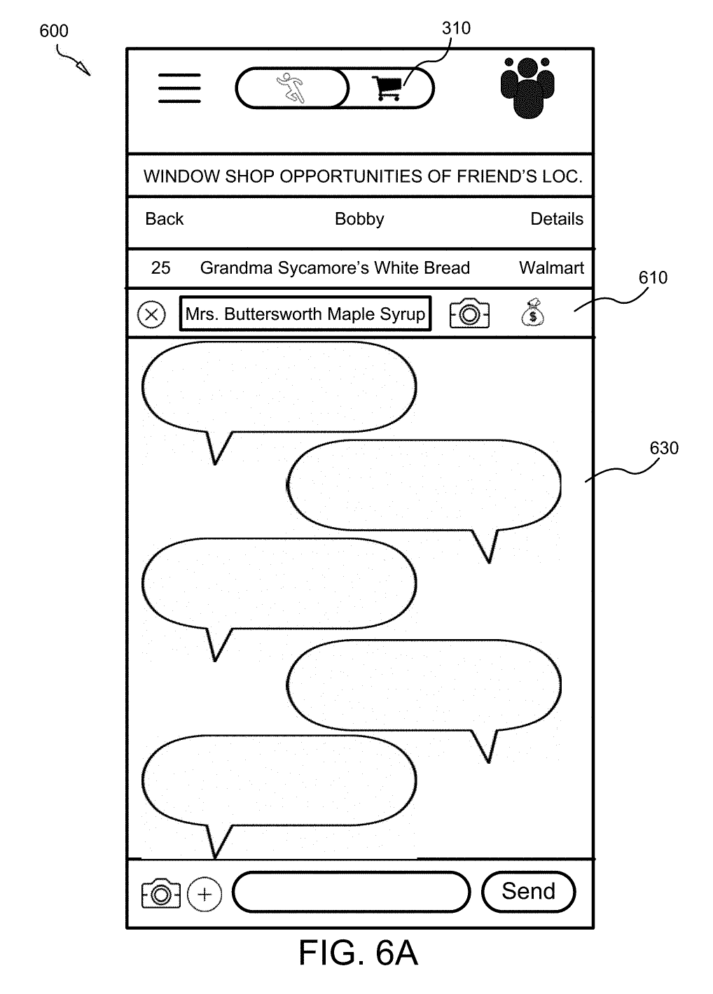

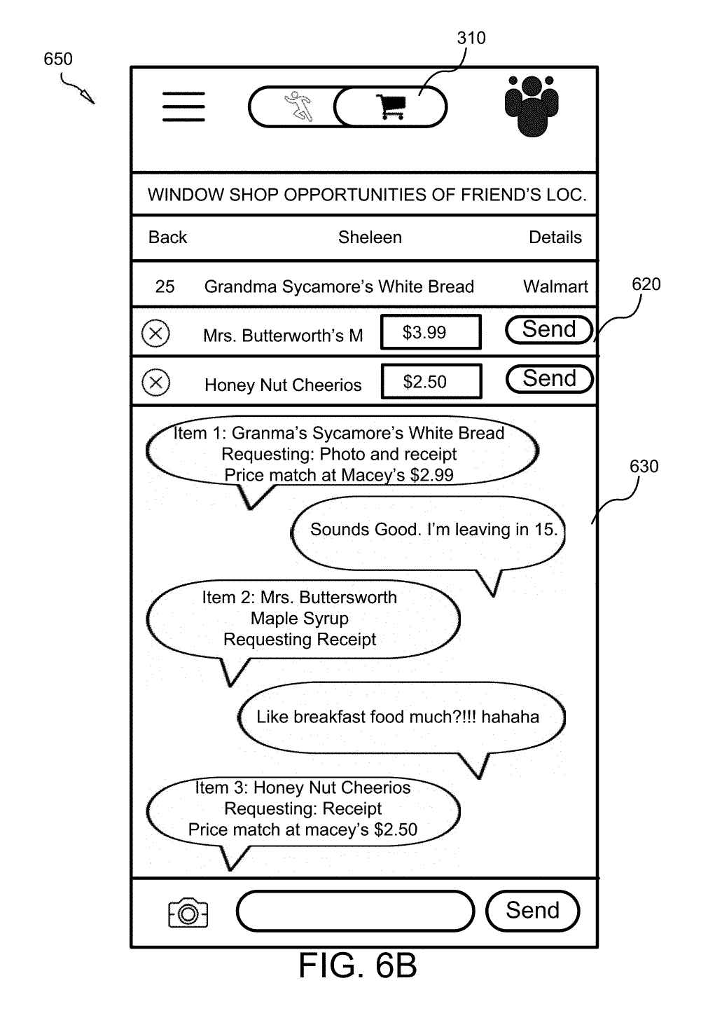

FIGS. 6A and 6B show a chat (or text) and order page, indicated generally at 600, 650 which allow a shopper to place a request, or an order, and chat with a transaction matched runner. FIG. 6A is the shopper's version of the screen with the switch 310 in the shopper position. In this page the shopper has multiple input fields 610 where the shopper can input various information for the runner to use in the transaction. FIG. 6B is the runner's version of the screen with the switch 310 in the runner position. In the runner's version of the page, the runner has input fields 620 where the runner/provider can input costs and other information for each item request about the product that is available at the runner's location thereby updating the shopper in real-time. The chat or order pages 600, 650 also have a chat field 630 where the runner and the shopper can chat via instant message about the transaction. Through the virtual displays and controls on the window shopping page 600, text shopping is facilitated between consumer and provider.

In this embodiment, real-time textual communication is facilitated between the consumer and provider. This real-time communication feature includes fields or drop-down menu controls, such as that indicated at 610, for making item request additions to the consumer request. These item request additions comprise descriptions and identifications of new products which the consumer would like added to the consumer request, including one or more of a name, and a manufacturer; and, in some embodiments, a maximum acceptable price.

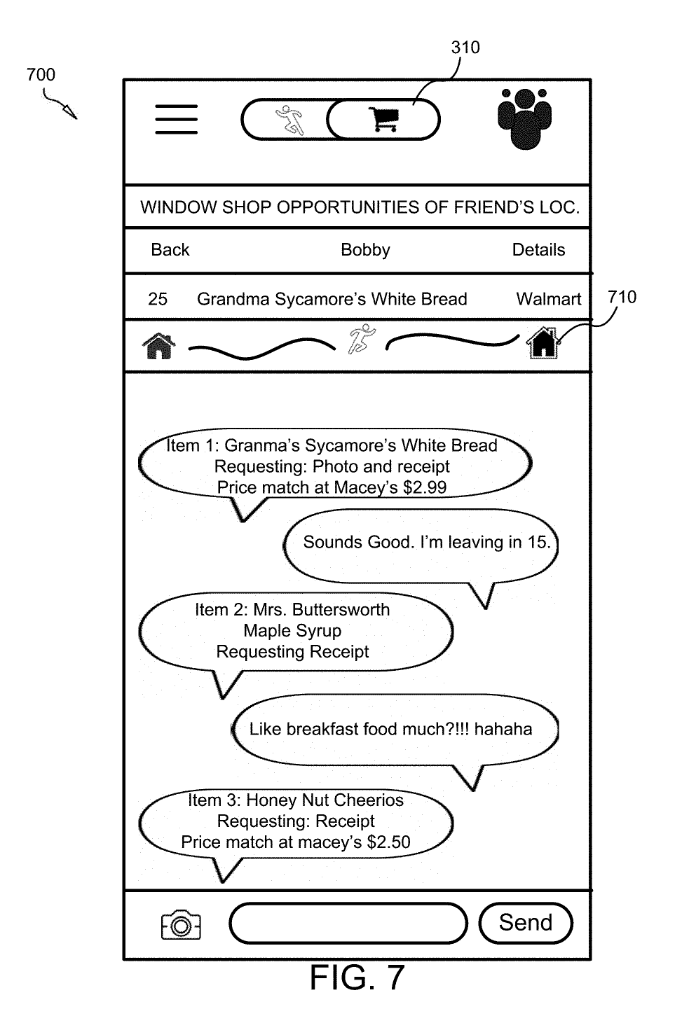

FIG. 7 shows an in-progress delivery page, indicated generally at 700, similar to the chat and order page 600, after the transaction has been accepted and the runner is in progress performing the transaction. The page 700 has a section 710 that shows the progress of the transaction and delivery as the runner completes the order. In this way, when the shopper has the screen in the shopper mode with the switch 310 in the shopper position, the shopper can monitor the runner's progress in real time.

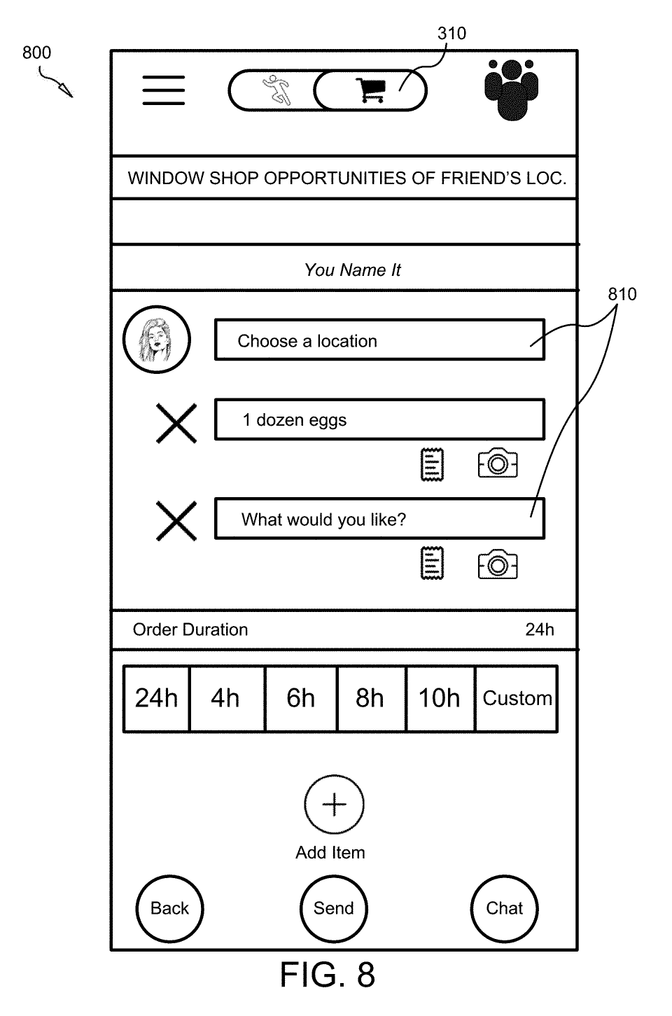

FIG. 8 shows an additional order screen, indicated generally at 800, for the shopper/consumer to input additional information about the transaction. The information input by the shopper using the virtual fields and controls is relayed to the technology provider and used by the technology provider to create an item request. In the shown embodiment, the shopper is unable to be matched by a matching module and/or algorithm with a provider, and the item request defined by the shopper/consumer is queued awaiting future match with a provider who does not have a projected delivery route.

In this case, when the shopper has the switch 310 set to the shopper setting, the shopper can indicate preferences for where the order should be filled, what brand and price the shopper desires, and any possible price matching. This type of data can be entered into the available input fields 810.

In various embodiments, virtual window-shopping is facilitated by the browser. In these embodiments, a provider 914 and/or a consumer may photograph one or more products and exchange the photographs with one another during a real-time delivery transactions, requesting additional consumer products be purchased and delivered or offering to purchase and deliver the same. Alternatively, the consumer and provider may exchange one or more media files comprising images and/or video and/or audio, including files in JPG, WAV, MP4 and other formats known to those of skill in the art.

In the shown embodiment, the item request addition is forwarded to the provider, who has previously been matched to the consumer, by accepting the consumer request. Alternatively, the item request addition may be included in a previously generated item request, or realize generation of a new item request, and forwarded to a plurality of providers.

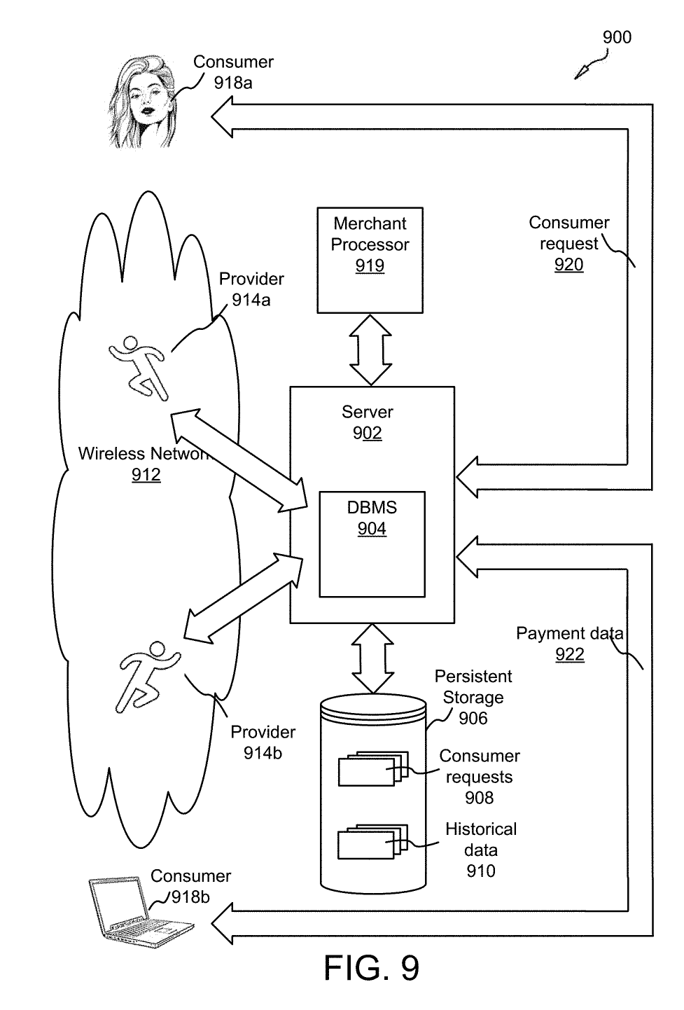

FIG. 9 is an entity-relationship diagram illustrating data flow between entities in accordance with the present invention.

The system 900 comprises a server 902, a database management system (DBMS) 904, persistent storage 906, stored consumer requests 908, stored historical data 910, a wireless network 912, consumers 918a-b, providers 914a-b, a merchant processor 919, a consumer request 920, and payment data 922.

Typically, the server 902 comprises one or more central processing units executing software and/or firmware to control and manage the other components within the system 900. In one embodiment, the server 902 comprises hardware and/or software more commonly referred to as a Multiple Virtual Storage (MVS), OS/390, zSeries/Operating System (z/OS), UNIX, Linux, or Windows system 100.

The server may comprise a server cluster with firewalls, load balancer, and database servers having Apache® and/or other software applications well-known to those of skill in the art. The server 902, in the shown embodiment, comprises a database management system (DBMS) 904 or relational database management system (RDBMS), such as Oracle, MySQL, SQL, FireBird, IBM DB2®, or the like.

The server 902 is in logical communication with one or more consumers 918 and one or more providers 914 (i.e., runners) through a networked environment 912, such as local area network (LAN) or wide area network (WAN). The server 902 may communicate with consumers 918 and/or runners/providers 914, sending queues, consumer requests 920, and commercial offerings 922, using variations of the Simple Mail Transfer Protocol (SMTP), Internet Message Access Protocol (IMAP), Post Office Protocol (POP), or other protocols well-known to those of skill in the art.

The computer 918b may comprise a smartphone which, internally or externally, may comprise an Interactive Voice Response (IVR), which recognizes natural voice communication or DTMF keypad input.

In the present invention, the server 902 routes information between consumers 918 and providers 914. The server 902 is in logical communication with the computer 918b. The server 902 is in logical communication via the Internet 912 with the cellular phones of consumers 918, or through other personal DPDs such as laptops, Palm Pilots®, digital cameras, and the like.

In the present invention, as further described in detail above and below, consumers 918 create consumer requests 920 on their computers 918 which are then relayed to the server 902. In alternative embodiments, the consumer requests are created by the providers. These consumer requests 920 comprise information about retail products, including perishable foods, which the consumer 918 would like delivered by one or more providers 914. The server 902 facilitates a real-time negotiation between the consumer 918 and provider 914 via a WAN such as the Internet.

In some embodiments, the server 902 collects payment from a consumer 918 after the consumer good(s) are delivered, then remunerates the providers 914 in accordance with a predetermined payment schedule mutually agreed upon by the provider 914 and one or more of: an organization managing a network interface (a technology provider) and a consumer 918.

The consumer 918 may comprise any person, company, or organization that is potentially a customer of another person, company, or organization. Each consumer 918 and provider 914 are incorporated into a marketing network comprising individuals and entities who have registered with the server 902. For the purposes of this patent, the terms “incorporate” and “incorporation” denote the act of formally enrolling a provider 914 or consumer 918 into the marketing network. Typically the provider 914 and consumer 918 are associated through social media or live within close geographic proximity to one another.

Providers 914 and consumers 918 become incorporated when they create accounts with the server 902 by uploading personal identifying information, including one or more of: an address, an email address, a telephone number, definition of purchasing practices, and the like. In typical embodiments, the registration takes place via a browser, but may also be sent to the server 902 using programs well-known to those of skill in the art, such as Microsoft Outlook, Thunderbird, Yahoo! Mail, and the like. In other embodiments, the consumers 918 and providers 914 are incorporated by receiving personal information via an API from a social media provider such as Google®, Facebook®, Twitter®, Instagram®, Snapchat®, or other social media providers known to those of skill in the art.

Like the consumers 918, the providers 914 may comprise any person, company, or organization that is potentially a merchant of another person, company, or organization. The consumer product may comprise any valuable item which can be purchased, tangible, or intangible. Examples of consumer products may include food, housing, electronics, books, gifts, digital media, guns, lodging, office supplies, legal services, medical services, insurance, construction contractors, or the like.

The computer 918 may comprise any system, apparatus, or computer program running on one or more data processing devices (DPDs), such as a server, computer workstation, router, mainframe computer, or the like. In various embodiments, the DPD comprises one or more processors. The processor is a computing device well-known to those in the art and may include an application-specific integrated circuit (“ASIC”).

Consumer requests 920 are stored in persistent storage 906. The merchant processor 919 is known to those of skill in the art, and may comprise a processor such as Elavon®, PayPal®, or the like.

In various embodiments, the server 902 may comprise, or be in logical communication with, an SMS gateway provider which relays short messages between the server 902 and/or one or more consumers 918 and providers 914.

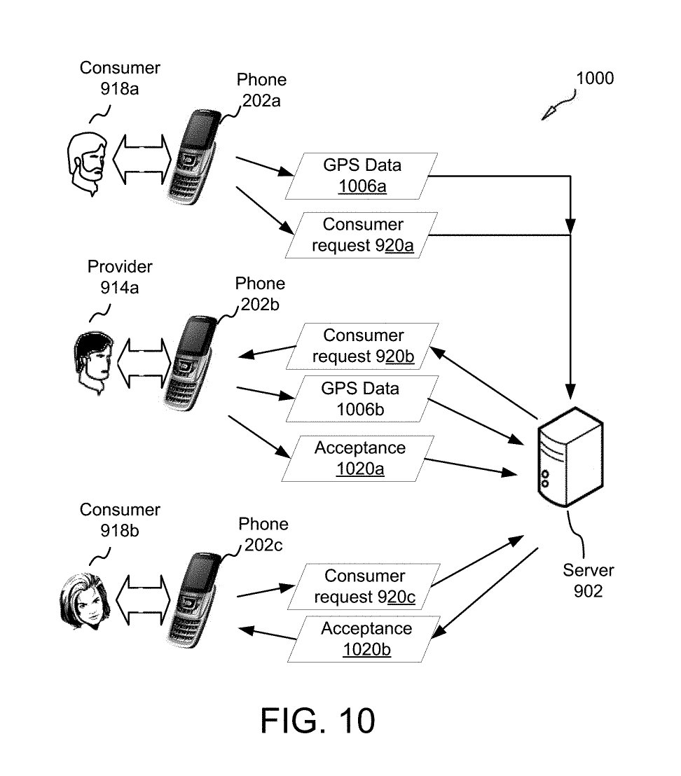

FIG. 10 is an entity-relationship diagram illustrating data flow between entities in accordance with the present invention.

Consumer requests 920 (i.e. item requests) are created on a cell phone 918b (or other DPD) and forwarded to a server 902, along with GPS data providing a consumer's 918 location. This GPS data, or geolocation data, may comprise a physical address or GPS coordinates and is stored in persistent or dynamic computer-readable memory. Providers 914 accept the consumer requests 920 and an acceptance 1020 is forwarded to the server 902 or technology provider.

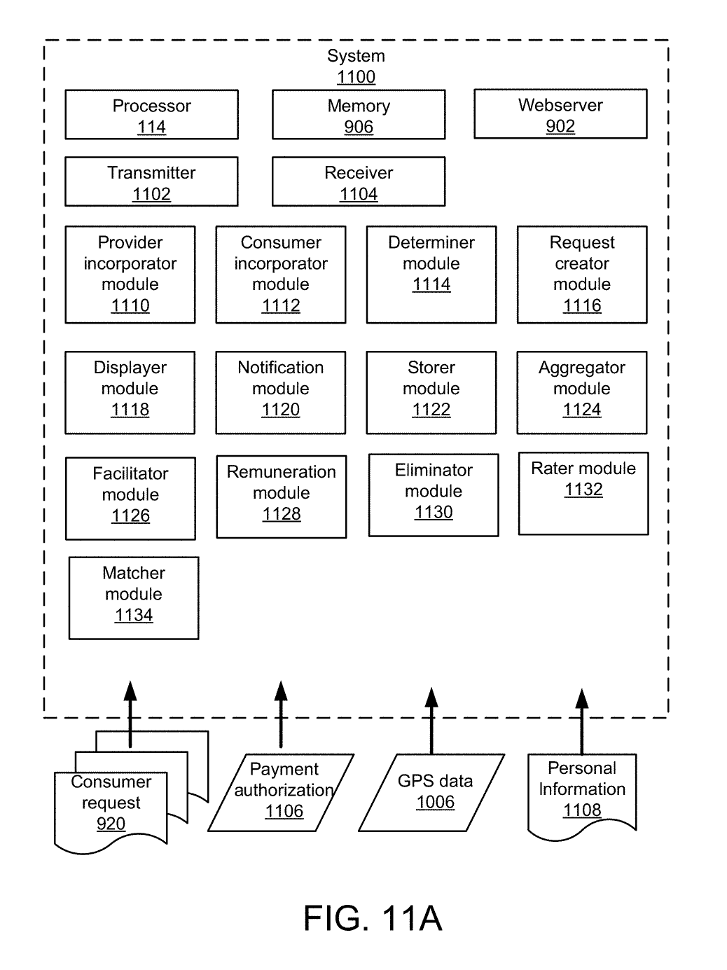

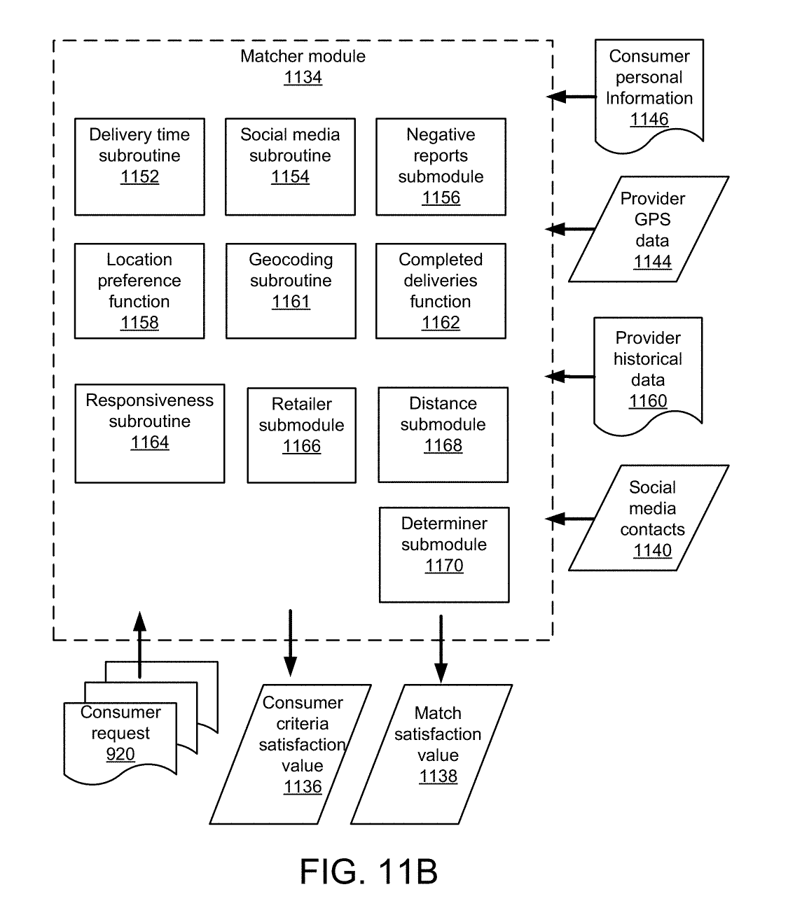

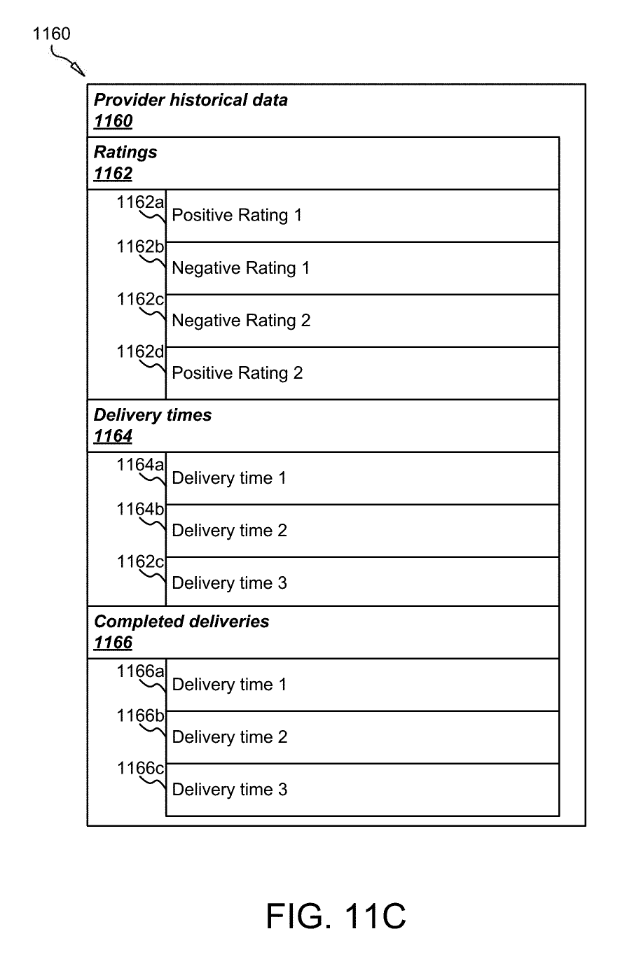

FIG. 11A is a block diagram illustrating modules of a system 1100 in accordance with the present invention.

Each of the modules 1110-1132 comprises the front end logic necessary to realize their respective described functions. The system 1100-1132 may comprise an application-specific integrated circuit (“ASIC”).

The system 1100 may comprise a transmitter and receiver with the logic necessary to receive and transmit bitstreams (i.e. data streams). The system 1100 modules may include the software, firmware, and hardware necessary to receive and process video content and media between consumers 918 and providers 914, including buffers, data unloaders, video unloaders, and the like. The system 1100 may also include a multiplexer functionally capable of demultiplexing packets in consumer requests 920, such as media comprising images of consumer requests or video in MPEG form and other formats known to those of skill in the art; analyzing the streams forming content units, such as elementary streams and program streams; remultiplexing media in consumer requests; and extracting consumer ID data from the consumer requests 920.

The system includes a request creator module 1116 which takes input from a consumer 918 and converts said input into a computer-readable file, such as a consumer request 920, which can be forwarded to providers 914.

In various embodiments, the determiner module 1114 determines which providers 914 are within a predetermined geographic area, including within a radius, around either the consumer 918 and/or a retail location offering a consumer product identified in the consumer request 920.

The consumer request 920 is received and stored in memory 906. Also received and stored are a payment authorization 1104 after delivery, GPS data 1006, and personal information 1108.

The notification module 1120 sends notifications to providers 914 that consumer requests 920 have been received, in some cases via SMS. The aggregator module 1124 aggregates money received from consumers, 918 for delivery of consumer goods, and distributes this money in part to providers 914 in accordance with a predetermined remuneration criteria, which predetermined remuneration criteria may be established by the technology provider.

A notification module 1120 is also shown and may be configured to relay the name of the provider 914 to the consumer 918 in response to determining one or more of: the distance is less than the radius value and the travel time is less than the time maximum. The notification module 1120 may also form part of the matcher module 1134. The notification module 1120 may also be configured to relay the name of the consumer 918 to the provider 914.

The provider incorporator module 1110 may be configured to identify a group of consumers within a polygonal area surrounding either a dynamic location of a provider or within a predetermined radius or area surrounding a projected route of travel for said provider. The provider GPS data (or geolocation) may be updated synchronously, or a synchronously, by the technology provider. Thus consumers going unidentified within the group of consumers at one instant may be identified using the same criteria in a later instant.

FIG. 11B is a block diagram illustrating a matcher module 1134 of a system 1100 in accordance with the present invention. As shown the matcher module 1134 may incorporate, comprise, or consist of, various submodules. In computer program product (CPP) embodiments and system embodiments, these submodules may comprise functions or subroutines in computer-readable code, as may the matcher module 1134.

Various parameters are passed to the matcher module 1134, including inter alia consumer personal information 1146, provider GPS data 1144, consumer GPS data, provider historical data 1160, social media contacts 1140, and a consumer request 920.

The matcher module 1134 may return various values or variables representing either satisfaction with a consumer selection criteria (such as consumer criteria satisfaction value 1136) or a numeral establishing a degree of satisfaction with a consumer selection criteria (such as match satisfaction value 1138).

In various embodiments, the matcher module 1134 comprises a delivery time subroutine 1152 which checks provider historical data 1160 to determine a number or percentage of on time deliveries for a provider 914.

The social media subroutine 1154 determines, from inter alia a social media contacts 1140 parameter, how many social media contacts the consumer 918 and provider 914 share in common. The social media contacts 1140 information may originate with an API returning data to the system 1100, such as Facebook®, Twitter®, or Google+® APIs as known to those of skill in the art.

The location preference function 1158 may determine whether a provider 914 is physically located (using provider GPS data 114 within a preferred location of the consumer 918). Preferred locations of consumers 918 may be passed as separate parameters comprising location names and/or location addresses and/or geolocation coordinates.

The completed deliveries function 1162 may determine from provider historical data 1160 how many or what percentage of previous consumer requests 920 accepted by a provider 918 have been delivered on time to a consumer 914.

The geocoding subroutine 1161 may convert GPS coordinates to mailing addresses or physical addresses, and vice versa, using means known to those of skill in the art, including APIs. Geocoding is the computational process of transforming a description of a location (textual information on addresses or places) to a location on the Earth's surface (spatial representation in numerical coordinates). The geocoding subroutine 1160 may comprise an API such as the Google Maps Geocoding API™, Google Maps Direction API™, Google Maps Javascript API™.

Geolocation information, as used herein, denotes information sufficient to identify in GPS coordinates the static location of an individual, residence, or physical location. This location, expressed in GPS coordinates, is the geolocation (or, alternatively, geolocation information or geostatic location).

In various embodiments, the match selection value 1138 is the sum of values returned by submodules/subroutines/functions 1152-1164. In other embodiments, the match selection value 1138 is a function of values returned by submodules/subroutines/functions 1152-1164.

The match selection value may, in one embodiment, be the sum of the social media contacts a consumer 918 and provider 914 share in common, the number of on-time deliveries of the provider 914, the number of completed deliveries of the provider 914, and the number of positive delivery reports of the provider 194. As provided above, the match selection value may be used to eliminate providers 914 from a group of providers relayed via signal-bearing medium to a consumer 914 in response to receiving a consumer request 920.

The matcher module 1134 may comprise an object or subroutine in source code, and may return a match satisfaction value, which may consist of any of the following variables (or data types): integer, char, short, long, float, double, long double, array, or others known to those of skill in the art.

Reduced to exemplary source code, the match satisfaction value might be assigned in a function call. Source code exemplifying the matcher module 1134 might, in basic form, include:

int matcher(char student_name, char consumer_name, int provider_gps)
{

int match_satisfaction_value;
match_satisfaction_value=deliverytime1152(provider_name)+socialconta
cts1154(provider_name, consumer_name)+reports1156(provider_name)+
geocoding1164(provider_gps);
...
return (match_satisfaction_value);

}

In other embodiments, the matcher module 1134 may also include a Boolean consumer selection criteria value which is evaluated as true if the match satisfaction value exceeds a predetermined constant as follows:
int matcher(char student_name, char consumer_name, int provider_gps)

{

const int PREDETERMINED_CONSTANT=10;
int match_satisfaction_value;
boolean consumer_selection_criteria_value=0;
match_satisfaction_value=deliverytime1152(provider_name)+socialconta
cts1154(provider_name, consumer_name)+reports1156(provider_name)+
geocoding1164(provider_gps);
...
for (match_satisfaction_value<=PREDETERMINED_CONSTANT;
consumer_selection_criteria_value++)
return (match_satisfaction_value, consumer_selection_criteria);

}

In this embodiment, if the match satisfaction value exceeds 10, the consumer selection criteria value would be increased (or evaluated as true). Once the consumer selection criteria value exclusively associated with a provider 914 for a particular consumer request 920 is evaluated as true, the provider 914 would satisfy the consumer selection criteria.

The provider_name is a global char, in the shown embodiment, which contains the name of the provider 914. In other embodiments, the provider_name is an int (or integer) consisting of a value exclusively associated with said provider 914.

The consumer_name is a global char, in the shown embodiment, which contains the name of the consumer 918. In other embodiments, the consumer_name is an int consisting of a value exclusively associated with a provider 918.

The provider_gps parameter is defined in the above functions as an int but could be passed as a char, array, string, float, or other data types known to those of skill in the art.

The matcher module 1134 may further comprise a retailer module 1166 configured to store in computer-readable memory names and addresses of a plurality of preferred retailers identified by the consumer 918. In various embodiments, the consumer 918 is prompted to identify and store in computer-readable memory the names and addresses of the plurality of preferred retailers from whom the consumer 918 who like to acquire consumer goods. In various embodiments, the consumer 918 may identify non-preferred retailers, or retailers from whom the consumer is not willing to acquire consumer goods.

The matcher module 1134 may also comprise a distance module 1168 configured to accept and store in computer-readable memory one of: a radius value, the radius value comprising a radius from a retail location within which a provider will deliver a consumer product; and a time maximum, the time maximum comprising a maximum delivery time from a retail location to the consumer within which a provider will deliver a consumer product. Both the radius value and time maximum are input by the consumer 918 to the technology provider (or system 1100).

A determiner module 1114 may also be included in system 1100, the determiner module 1114 configured to determine a distance between the consumer and the retail location by passing parameters to an API, the parameters comprising: geolocation information of the consumer and the address of a preferred retailer; and determine a travel time between the consumer and the retail location by passing parameters to an API, the parameters comprising: geolocation information of the consumer and the address of a preferred retailer.

FIG. 11C is a data layout diagram illustrating provider historical data 1160 in accordance with the present invention. As shown, the provider historical data 1160 may comprise a plurality of ratings 1162, which are previous consumer 918 ratings of the provider 914 with respect to previous consumer requests 920. These ratings 1162 may comprise simple good or bad ratings, ratings 1162 of one to five stars, ratings 1162 of one to ten, ratings 1162 of one to one hundred, and the like.

The provider historical data 1160 also comprises delivery times 1164 exclusively associated with previous consumer requests. The provider historical data 1160 may be expressed in days, minutes, hours, seconds, and as otherwise known to those of skill in the art. The provider historical data 1160 may also comprise a list of previous consumer requests 920 which were successfully delivered, or simply a value indicating the sum of successful deliveries (and a corresponding value indicating the sum of unsuccessfully delivered consumer goods).

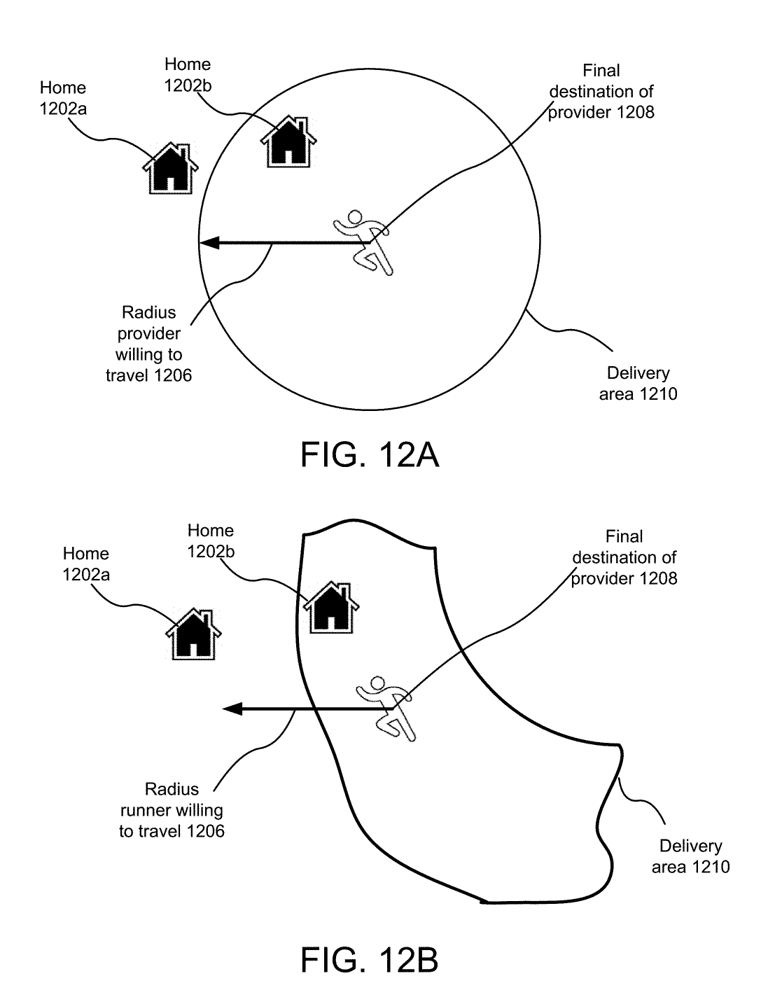

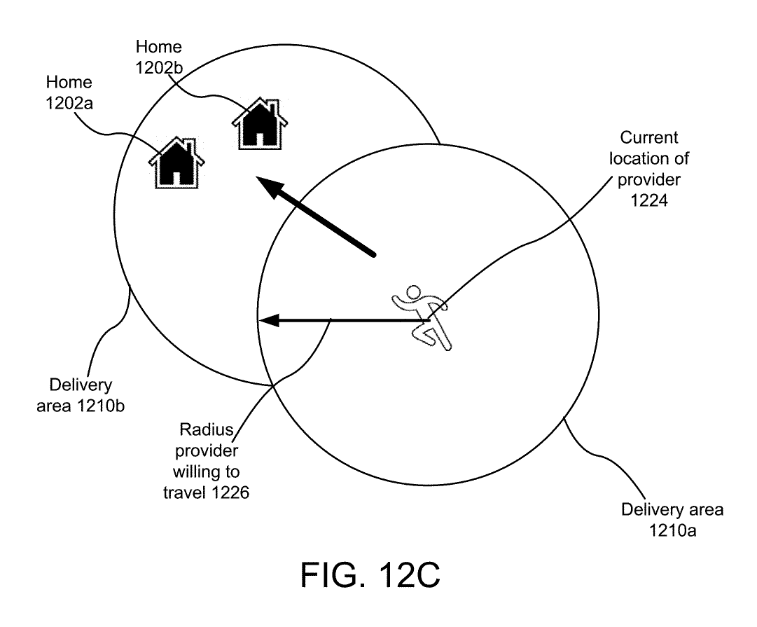

FIG. 12A is an entity-relationship diagram illustrating modules of a system in accordance with the present invention. In various embodiments, a consumer selection criteria is satisfied only with respect to provider 914 being geolocated within a predetermined radius of a consumer, or with respect to providers 914 who are willing to travel or deliver a consumer product to a consumer 918 within a predetermined area. Alternatively, a determination by the matching module 1134 and/or other modules of the system 1100 take into account the radius a provider 914 is willing to deliver a good as one consideration in matching a consumer 918 with a provider 914.

A provider 914 inputs geolocation data defining the provider's 914 final destination 1208, which may be the provider's 914 home, final delivery destination, work, school, and the like.

In various embodiments, the provider 914 defines a radius 1206 from the final destination 1208 within which the provider 914 is willing to travel to deliver a consumer good.

In the shown embodiment, home 1202b is within the radius 1206 but home 1202a is outside the radius 1206. A consumer request 920 originating within home 1202a would not be forwarded to the provider 914 for acceptance while a consumer request 920 originating within home 1202b would be forwarded/relayed to the provider 914. Homes 1202 within the delivery window 1210 (defined by the radius 1206 and final destination 1208) are candidates for delivery of consumer good.

FIG. 12B is an entity-relationship diagram illustrating modules of a system in accordance with the present invention. In various embodiments, the delivery area 1210 is polygonal. The provider 914 may define an irregularly-shaped delivery window (or delivery area) 1210 using means known to those of skill in the art, including through interaction with one or more APIs. Using this method, homes 1202 outside the radius 1206 may still be candidates for provider 914 delivery.

FIG. 12C is an entity-relationship diagram illustrating modules of a system in accordance with the present invention.

In various embodiments, the delivery window 1210 is defined not by the final destination 1208 but by the provider's 914 current dynamic location 1224. In these embodiments, the delivery area 1210a shifts with the shifting location of the provider 914. Thus, a consumer request 920 originating in home 1202a might be ineligible for acceptance by the provider 914 at one point in time, but eligible a few minutes or hours at a later time. A computer-implemented method may automatically notify a consumer 918 if a provider 914 comes within the area 1210a of the consumer's home 1202.

As mentioned previously, the consumer good may comprise any product transportable by motorized vehicle, including foods, hardware, clothing, shoes, office supplies, medication, movie rentals, cleaning supplies, photographs, books, and the like.

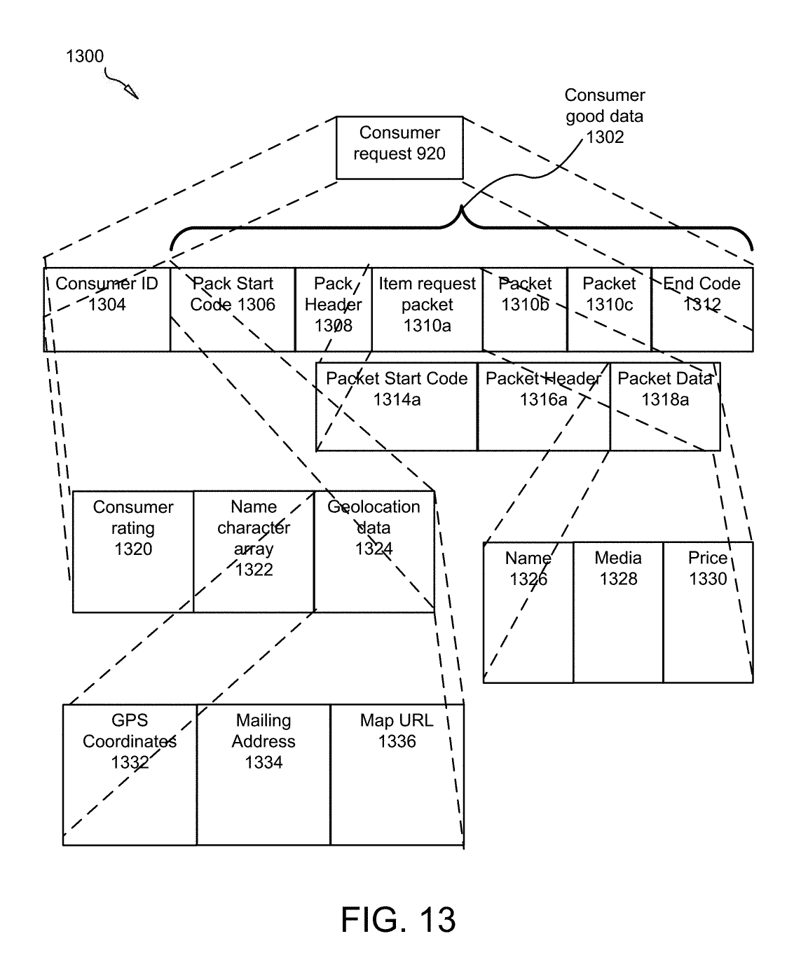

FIG. 13 is a data layout diagram illustrating one embodiment of a consumer request 1300 in accordance with the present invention.

The consumer request 1300 comprises, in some embodiments, a computer-readable file stored in persistent memory 124 under the control of a database management system (DBMS) or a relational database management system (RDBMS). The consumer request 1300 (or 920) may be transmitted over a signal-bearing medium to providers 914 and/or to consumers 918.

The term “consumer request” is used throughout this disclosure synonymously with the terms “item request” and “item request addition.”

The technology provider, or server 902, in the shown embodiment, may comprise one or more computer programs running on one or more data processing devices (DPDs), such as a server 902, computer workstation, router, mainframe computer, or the like. In various embodiments, the DPD comprises one or more processors or remotely networked DPDs.

The consumer request 1300 comprises various content units or packets, which, in various embodiments of the present invention, may comprise strings, arrays, integers, video signals, audio signals, URLs, separate computer files, and the like.

In the shown embodiments, a technology provider receives, encodes, and/or modifies the consumer request 920 (which alternatively becomes a consumer request 1300), then relays the consumer request 1300 to one or more consumers 918 or providers 914. The consumer request 1300 may be broadcast and encoded in one of any number of various data encodings well-known to those of skill in the art.

The consumer request 920 may comprise a consumer ID packet 1304. The consumer ID 1304 may comprise an integer representing a consumer 918 rating 1320, a string representing the name of a consumer 918, and geolocation data 1324 comprising integers or floating points representing global positioning system (GPS) coordinates 1332. The consumer ID 1304 may also comprise a character string representing a mailing address and/or physical address of the consumer 918.

The consumer request may comprise a plurality of item request packets 1310. In various embodiments, these packets 1310 comprise information about a consumer good the consumer 918 wishes to purchase via a provider 914, has purchased via provider 914, or prospectively may be interested in having a provider 914 purchase. The consumer request 1300 may consist of a single item request packet 1300 in embodiments in which a consumer 918 originates a consumer request 1300.

However, in various other variations of the consumer request 1300, a consumer 918 chooses during real-time textual communication with a provider 914 to add an item request addition to the consumer request 1300. The consumer 918 may add a plurality of item request additions to the consumer request 1300, all of which may be stored in sequence in the consumer request 1300 in consecutive item request packets 1310.

The item request packets 1310 may comprise a name 1326 of the consumer 918 or provider 914 originating the consumer request 1300, a media file 1328 comprising an image or video of a consumer good, and a price 1330 of the consumer good. In other variations, the packet 1310 comprises a Boolean representing whether the price 1330 has been accepted, and in still further variations the packet 1310 comprises a delivery confirmation Boolean representing whether a consumer good described in the packet 1310 has been delivered. This is an exemplary constitution of a consumer request 920 (or item request 920).

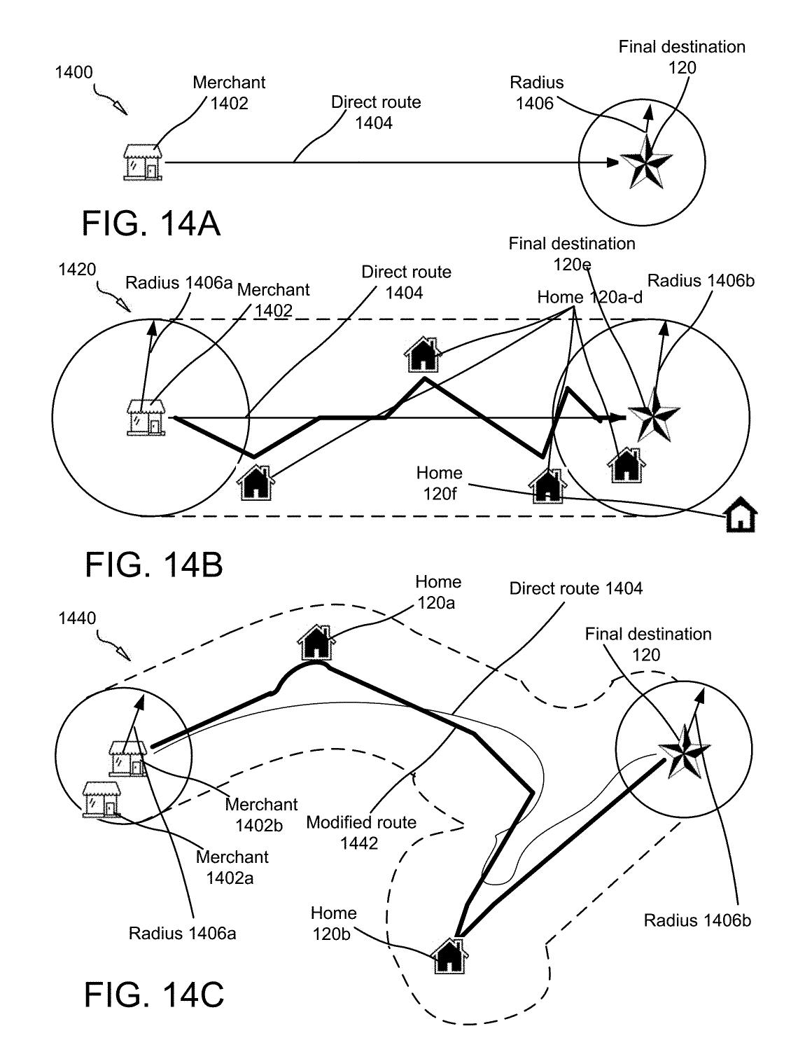

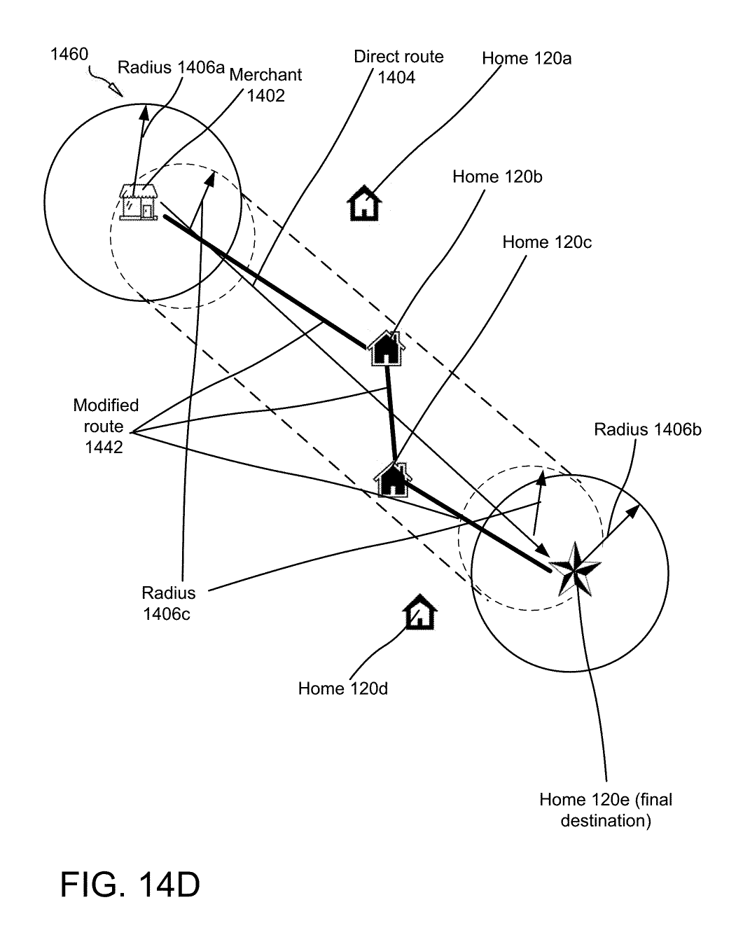

FIG. 14A is a data-entity diagram illustrating one a method 1400 of matching a provider and consumer in accordance with the present invention. Illustrated are a merchant 1402, a direct route of travel 1404, a radius 1406, and a home 120 (which home 120 is the final destination in the shown embodiment recognizing the final destination may also be a delivery address other than a home 120).

In the shown embodiment, a provider 914 (not shown) is geolocated at a position corresponding to a merchant 1402. This provider and merchant 1402 may be located outside of a circular geographic area surrounding a home 120, to which final delivery of a consumer good is realized by the provider. This geographic area is defined by a radius 1406b.

In the shown embodiment, the provider 914 is matched with the consumer 918 residing at the home 120 simply because the provider 914 is geolocated at a merchant on the preferred merchant list. The provider 914 takes the fastest direct route of travel 1404 to the home 120. In other embodiments described below, more complex matching algorithms are employed.

FIG. 14B is a data-entity diagram illustrating one a method 1420 of matching a provider and consumer in accordance with the present invention. Illustrated are a merchant 1402, a direct route of travel 1404, radii 1406a-b, and homes 120a-f (home 120e is the final destination).

In the shown embodiment, the technology provider matches a provider 914 with a consumer using a more sophisticated algorithm. The provider 914 is geolocated within a radius 1406a of the place of business of a merchant 1402. The radius 1406a is defined by the provider at a home 120d having a final delivery address. The merchant 1402 may be a merchant on a preferred merchant list.

The provider 914 specifies or defines a radius 1406b within which the provider 914 is willing to deviate from the direct route 1404 of travel to make deliveries to additional homes 120 from which consumers 918 have submitted item requests (or item request additions or consumer requests).

Thus, in this embodiment, the provider 914 is matched to the consumer 918 based on the provider 914 being geolocated within a radius 1406a defined by the provider 914, the radius 1406a being a radius from a merchant 1402 on a preferred merchant list. Subsequent consumers 918 (submitting or accepting item requests to the provider 914) are added to the delivery route if their residence, final destination, or delivery address is within a radius 1406b (or distance) defined by the provider 918 of any point on the provider's 918 direct route 1404 of travel.

FIG. 14C is a data-entity diagram illustrating one a method 1440 of matching a provider and consumer in accordance with the present invention. Illustrated are merchants 1402a-b, a direct route of travel 1404, radii 1406a-b, and homes 120a-d and final destination 120e (which also happens to be a home 120).

As above, the illustrated method 1440 and algorithm provide for the provision of consumers 918, or the matching of consumers 918 with a provider 914, whose delivery addresses are within a radius 1406b of a delivery route, however the delivery route from which the radius 1406b is measured is a modified route 1442 not the direct route 1402. Using this form of matching, homes 120 such as home 120b which would fall outside the provisions of the matching algorithm illustrated in FIG. 14B above are nonetheless added to the modified route 1442.

In the shown embodiment, the modified route 1442 is modified in shape as new consumers 918 and/or new homes 120 (or delivery locations) are matched with the provider 914 traveling the modified route 1442.

Also as shown, the direct route 1404 is not necessarily a straight line, but may form an irregularly shaped line formed to conform to applicable roads in response to traffic patterns as dictated by reference of the technology provider to a routing function or module, which is an API in various embodiments.

FIG. 14D is a data-entity diagram illustrating one a method of matching a provider and consumer in accordance with the present invention. Illustrated are a merchant 1402, radi 1406a-c, a direct route 1404, homes 120a-e, and a modified route 1442.

The direct route 1404 represented the direct route plotted by the technology provider in accordance with the present invention. Although the direct route 1404 is shown as a straight line for illustrative purposes, in reality the direct route 1404 may meander or be plotted by the technology provider to optimize a travel time of the provider to the home 120e (as further shown in relation to FIG. 12C).

Importantly, consumers 918 residing at homes 120b-d, who create new item requests, may be added to the provider's 914 route if a delivery address associated with the new item request falls within either a radius 1406b surrounding the provider's final destination (home 120e) or within a radius 1406c surrounding the direct route 1404.

Using this methodology, the delivery locations of new item requests must satisfy one of two criteria: (1) being within a predetermined radius 1406c of the direct route 1404, or (2) being within a predetermined radius 1406b of the final destination and home 120e. The criteria may be the radius parameters. The radi 1406a-c are radius values.

For exemplary purposes, the radius 1406b is 1 mile in the shown embodiment while radius 1406c is 0.5 miles (though not shown to scale).

Because home 120d falls outside both radi 1406b-c, and fails to satisfy both of these criteria, home 120d is not added to the delivery schedule nor does it result in replotting of the modified route 1442.

Reference is made to a location of the provider 914 when determining whether the merchant 1402 falls within a radius 1406a from the provider's 914 location. Because the provider's 914 location may be constantly shifting (the provider's 914 shifting dynamic location), this reference may be made repeatedly or continuously.

In other various embodiments, the provider 914 may specify that the modified route 1442 should become the direct route 1404 for the purposes of adding yet additional item requests to the provider's 914 plotted route, thus creating a new modified route 1442.

In various embodiments of the present invention, input from an API is used by the technology provider to determine a deviation time for each potential new delivery location sought to be added to a modified route 1442. In various embodiments, new homes 120 are added to the modified route 1442 not if they fall within a predetermined radius 1406, but if the deviation time for each potential new delivery location (or potential new home 120 in some embodiments) falls below an acceptable deviation threshold defined by the provider 914. “Travel parameters” may therefore be satisfied if: (1) a potential new delivery location falls within the radius 1406, or (2) if the deviation time for the potential new delivery location as determined from API input falls below an acceptable deviation threshold.

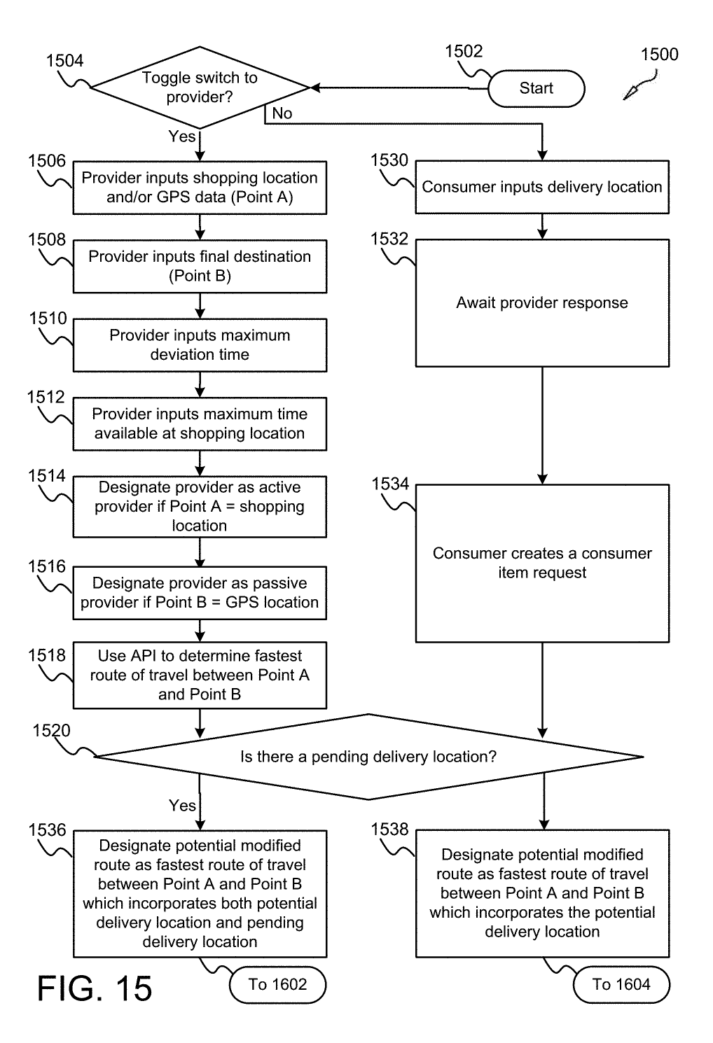

FIG. 15 is a flow chart illustrating the steps of a method 1500 of matching a provider and consumer in accordance with the present invention.

Virtual controls 310 in the browser provide functionality to a user to toggle back-and-forth between a consumer input protocols and provider input protocols. If 1504 a user toggles to consumer input protocols the method 1500 progresses 1530. If the user toggles to provider input protocols the method 1500 progresses 1506.

Many of the steps of methods 1500-2000 are substantially described above or not in need of description supplemental to that shown in FIGS. 15-20.

In accordance with the steps of method 1500, a provider 918 inputs 1506 a shopping location and/or GPS data which is designated Point A.

The provider 918 may input 1508 a final destination which is designated Point B. The provider 918 may input 1510 a maximum deviation time, designated as a value in an integer in computer-readable memory. The provider 918 may also input 1512 a maximum time available at a shopping location.

The technology provider designates 1514 the provider 918 as a passive provider if Point B equals or correlates to the GPS location. An API may be used 1518 to determine the fastest route of travel between Point A and Point B.

If 1520 there is a pending delivery location the method 1500 progresses 1536 by designating a potential modified route as the fastest route of travel between Point A and Point B which incorporates both the potential delivery location and pending delivery location.

If 1520 there is not a pending delivery location the method 1500 progresses 1538 by designating a potential modified route as the fastest route of travel between Point A and Point B which incorporates the potential delivery location.

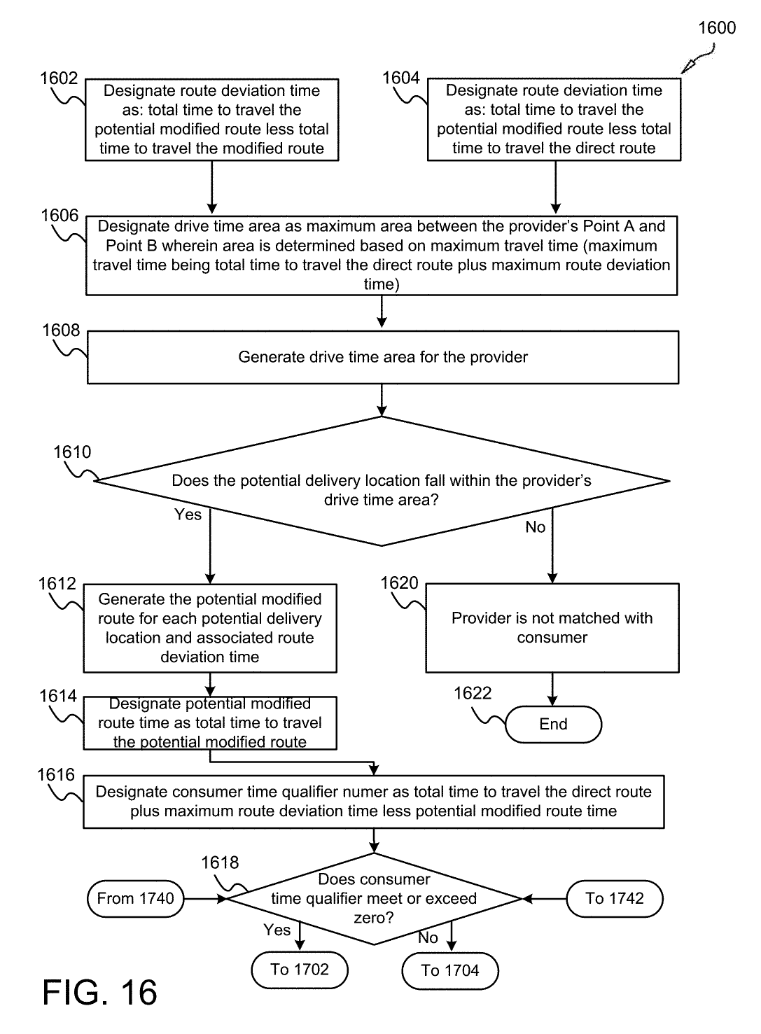

FIG. 16 is a flow chart illustrating the steps of a method 1600 of matching a provider and consumer in accordance with the present invention.

The technology provider designates 1602 a route deviation as the total time to travel the potential modified route less the total time to travel the modified route.

The technology provider may designate 1604 route deviation time as the total time to travel the potential modified route less total time to travel the direct route.

The technology provider designates 1606 drive time areas as a maximum areas between the provider's 918 Point A and Point B wherein area is determined based on maximum travel time.

If 1610 the potential delivery location falls within the provider's 918 drive time area the method 1600 progresses 1612 with the technology provider generating the potential modified route for each potential delivery location and associated route deviation time.

The technology provider may designate 1616 a consumer time qualifier as the total time to travel the direct route plus the maximum route deviation time less potential modified route time.

If 1618 the consumer time qualifier meets or exceeds zero, the method 1600 progresses 1702. Otherwise, the method 1600 progresses 1704.

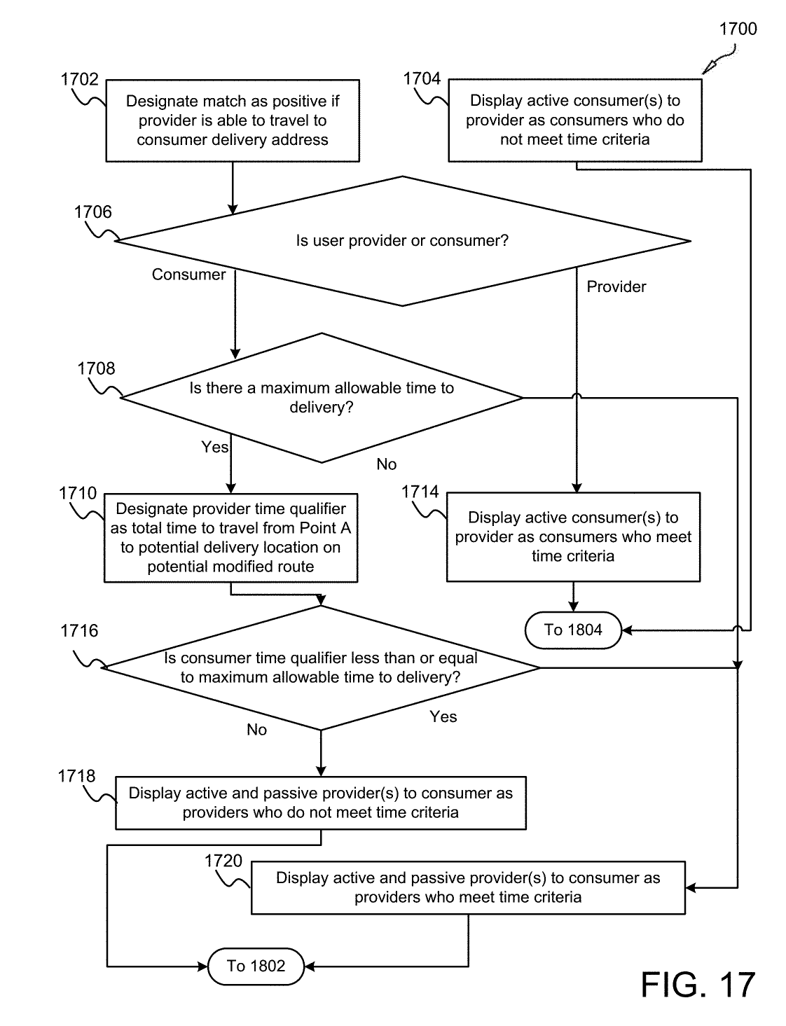

FIG. 17 is a flow chart illustrating the steps of a method 1700 of matching a provider and consumer in accordance with the present invention.

The technology provider may designate 1702 a match as positive if the provider 918 is able to travel to the consumer delivery address. The technology provider may display active consumers 914 to the provider 918 who do not meet time criteria.

If 1706 the user is a provider 918, the method 1700 progresses 1714 and active consumer(s) 914 are displayed to the provider 918. If 1706 the user is a consumer 914, the method 1700 progresses 1710 and the technology provider designates 1710 a provider time qualifier as the total time to travel from Point A to the potential delivery location on a potential modified route.

If 1716 the consumer time qualifier is less than or equal to the maximum allowable time to delivery, the method 1700 progresses 1720 and then 1802. Otherwise, the method 1700 progresses to display 1718 active and passive providers to a consumer 914 as providers 918 who do not meet the time criteria.

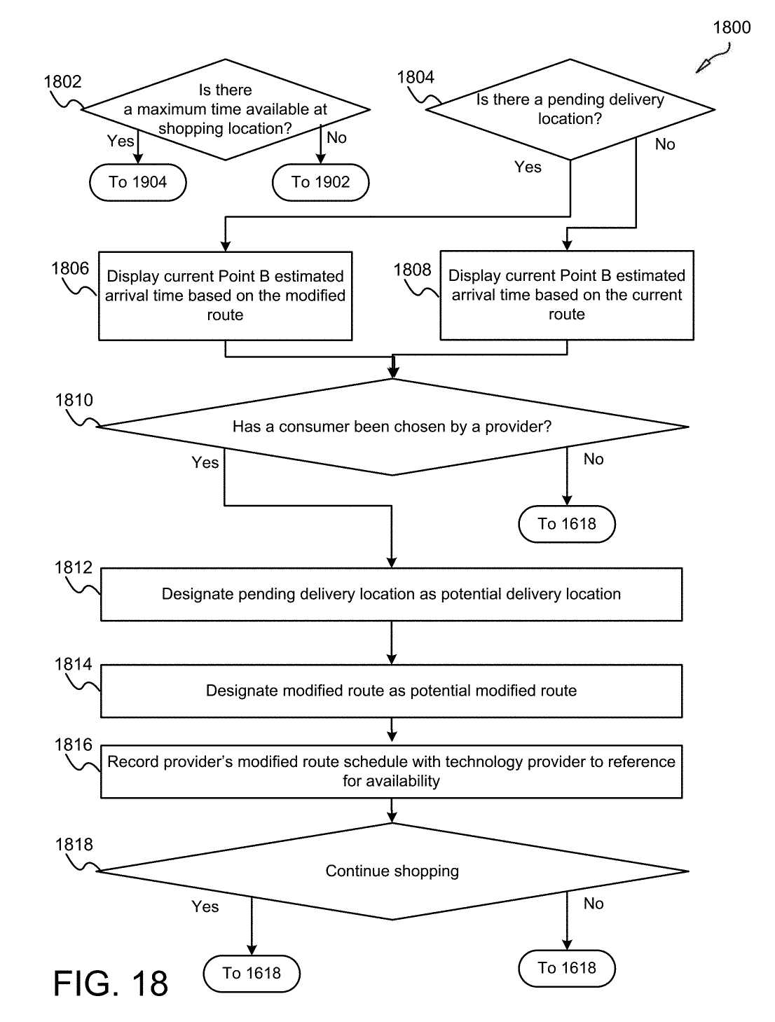

FIG. 18 is a flow chart illustrating the steps of a method 1800 of matching a provider and consumer in accordance with the present invention.

If 1802 there is a maximum time available at a shopping location, the method 1800 progresses 1904. Otherwise the method 1800 progresses 1902.

If 1810 a consumer 914 has been chosen by a, or the, provider 918, the method progresses 1812 and the technology provider designates a pending delivery location as the potential delivery location and designates 1814 the modified route as a potential modified route.

The provider's 918 modified route schedule is recorded 1816 with the technology provider for future reference.

If 1818 the consumer 914, or provider 918, desires to continue shopping, the method 1800 progresses 1618.

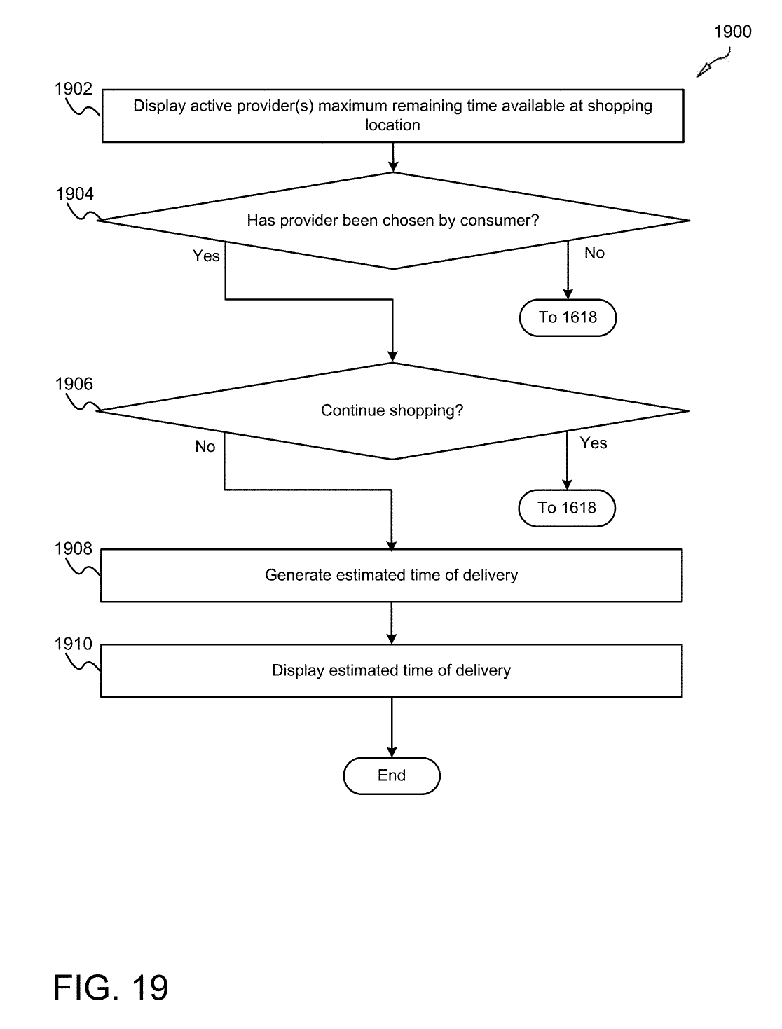

FIG. 19 is a flow chart illustrating the steps of a method 1900 of matching a provider and consumer in accordance with the present invention.

If 1904 a provider 918 has been chosen by a consumer 914 the method 1900 progresses 1906. Otherwise, the method 1900 progresses 1618.

If 1906 the consumer 914, or provider 918, desires to continue shopping, the method progresses 1618.

The technology provider may generate 1908 an estimated time of delivery and display 1910 the estimated time of delivery.

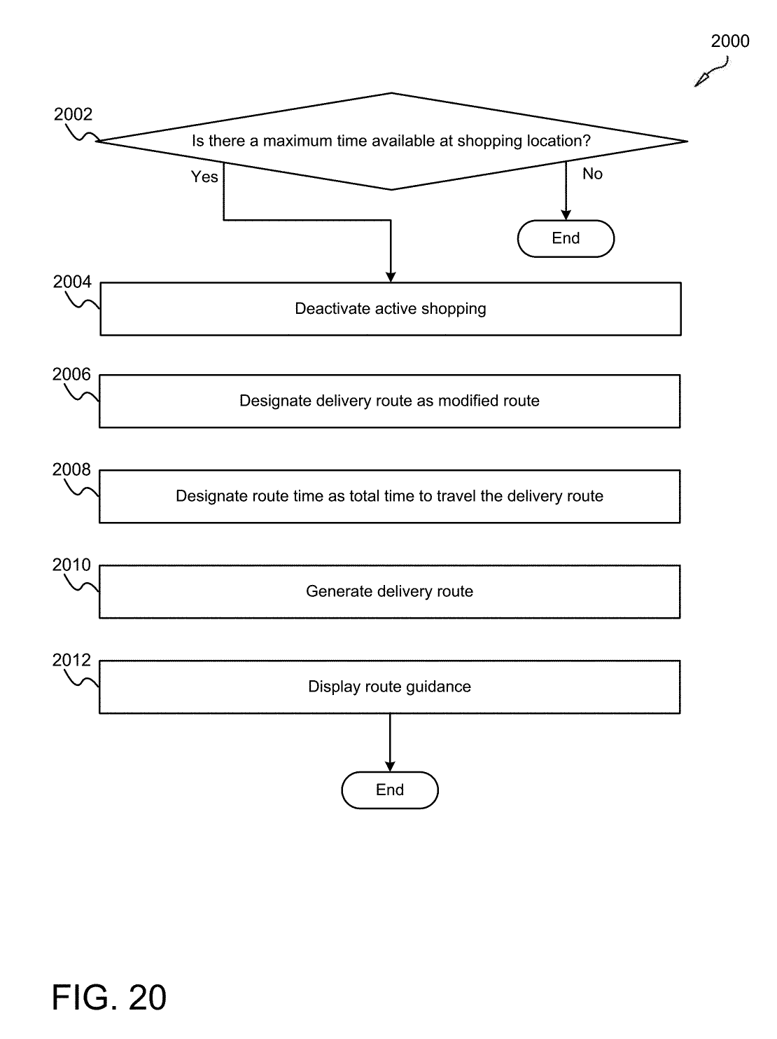

FIG. 20 is a flow chart illustrating the steps of a method 2000 of matching a provider and consumer in accordance with the present invention.

If 2002 there is a maximum time available at a shopping location, the method 2000 progresses 2004 and the technology provider deactivates active shopping. The method 2000 proceeds as shown, with a delivery route being generated 2010 using an API and route guidance display 2012. Otherwise, the method 1900 ends as shown.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer-implemented method for brokering a real world transaction, the steps of the method comprising:
accepting into computer-readable memory on a signal bearing medium geolocation information of a plurality of consumers and a plurality of providers;
accepting into computer-readable memory a delivery location from each of the plurality of consumers, the delivery location exclusively associated with a consumer;
accepting into computer-readable memory from each of the plurality of providers, a final destination, a provider's route of travel, and travel parameters around the route of travel;
wherein the final destination, the route of travel, and the travel parameters are exclusively associated with the provider;
accepting into computer-readable memory a shopping location from one or more of: a plurality of consumers and a plurality of providers;
identifying a group of consumers whose accepted delivery locations which are enveloped by the travel parameters around the route of travel;
identifying a group of providers exclusively associated with routes of travel that envelope one or more accepted delivery locations of the plurality of consumers;
relaying the identified group of consumers to one or more providers;
relaying the identified group of providers to one or more consumers;
facilitating real-time bi-directional textual communication exclusively between a consumer whose delivery location satisfies travel parameters exclusively associated with a provider's route of travel and the provider exclusively associated with the travel parameters;
accepting into computer-readable memory an item request originating with a consumer, the item request comprising a name of a consumer good;
relaying to the provider within real-time textual communication with the consumer an item request originating with the consumer;
recording into computer-readable memory a provider response to the item request, the provider response comprising an integer indicative of a price of the consumer good;
recording into computer-readable memory a consumer acceptance of the provider response;
relaying to the provider a Boolean value evaluating as true in response to consumer acceptance of the provider response; and
receiving and storing into computer-readable memory a delivery confirmation originating with the consumer in response to a provider delivering the consumer good.

2. The method of claim 1, wherein the travel parameters consists of one of:
a predetermined radius; and
and a predetermined deviation time from the provider's route of travel.

3. The method of claim 1, further comprising eliminating providers from the group of providers who fail to satisfy a consumer selection criterion.

4. The method of claim 2, wherein the consumer selection criterion is satisfied upon reference to historical data exclusively associated with the provider in persistent computer-readable memory establishing:
average delivery time of consumer goods for the provider is within a predetermined interval of time;
the provider is associated on social media with more than a predetermined number of contacts of the consumer;
the provider has less than a predetermined threshold of negative reports from consumers; and
a geolocation of the provider is at a location preference of the consumer.

5. The method of claim 2, wherein the consumer selection criterion comprises one or more of:
reaching a threshold of on time deliveries;
reaching a threshold of completed deliveries;
reaching a response threshold to real-time communication attempts of previous consumers; and
being within a preferred location.

6. The method of claim 4, further comprising:
organizing the providers into one of the following abstract data types into computer-readable memory: a stack, a queue, an associative array; and
graphically displaying those providers in the abstract data type on a GUI who satisfy a plurality of consumer selection criteria.

7. The method of claim 1, further comprising:
displaying a plurality of providers at a specified geolocation; and
accepting into computer-readable memory a selection from a consumer of one of the plurality of providers.

8. The method of claim 1, where the facilitating of real time textual communication comprises displaying a virtual field in which an item request is identified by the consumer using one of:
a character string manually created on a touch display; and
a drop-down virtual menu;
and wherein the item request is added to a computer-readable file comprising the consumer request in an RDBMS.

9. The method of claim 1, wherein the consumer good comprises one of a perishable food, a digital media, an item of clothing, an appliance, and an electronic device.

10. The method of claim 1, wherein the step of facilitating real-time textual communication further comprises:
displaying a history of textual communications between the consumer and the provider;
receiving into computer-readable memory from the consumer an item request;
relaying the name of the item request to the provider;
relaying the digital media of the item request to the consumer;
receiving into computer-readable memory a price in the form of a integer set by the provider for the item request; and
accepting an uploaded Boolean value from the consumer representing acceptance or rejection of the price set by the provider.

11. The method of claim 10, further comprising:
receiving from the provider a digital media over a signal-bearing medium, the digital medium comprising an image of the item request; and
receiving from the provider a digital media comprising an image of a receipt for purchase of the item request.

12. The method of claim 11, further comprising facilitating real-time video communication between the provider and the consumer originating the item request, the real-time video communication commenced in response to the consumer selecting the provider's acceptance of the consumer request.

13. The method of claim 1, further comprising facilitating real-time textual communication between the consumer and a plurality of providers having accepted consumer requests, the real-time video communication commenced in response to the consumer receiving a plurality of acceptances from the plurality of providers.

14. The method of claim 1, further comprising:
adding a flat rate tip value to the price of a sum of all prices relayed to the consumer by the provider, the flat rate tip value predetermined by a third-party without input from the consumer and provider; and
preventing the consumer and provider from augmenting or reducing a remuneration total predetermined by the remuneration criteria.

15. The method of claim 1, further comprising matching the consumer with a provider, the steps of matching the consumer with a provider comprising:
storing into computer-readable memory names and addresses of a plurality of preferred retailers, the names and addresses of the plurality of preferred retailers originating with the consumer;
storing in computer-readable memory a radius value, the radius value comprising a radius from a retail location within which a provider will deliver a consumer product;
determining a distance between the consumer and the retail location by passing parameters to an API, the parameters comprising: geolocation information of the consumer and the address of a preferred retailer; and
relaying the name of the provider to the consumer in response to determining that the distance is less than the radius value.

16. The method of claim 1, further comprising matching the consumer with a provider, the steps of matching the consumer with a provider comprising:
storing in computer-readable memory a time maximum, the time maximum comprising a maximum delivery time from a retail location to the consumer within which a provider will deliver a consumer product;
determining a travel time between the consumer and the retail location by passing parameters to an API, the parameters comprising: GPS coordinates of the delivery address and GPS coordinates of the retail location; and
relaying the name of the provider to the consumer in response to determining that the travel time is less than the time maximum.

17. A computer program product comprising a signal bearing computer-readable medium having computer-usable program code executable for brokering a real world transaction, the operations of the computer program product comprising:
accepting a geolocation of a consumer and a provider;
storing a consumer request from a consumer, the consumer request comprising a name of a consumer good;
identifying a group of consumers within a predetermined polygonal area surrounding the geolocation of a provider who is available for purchasing a consumer good and who is associated with the consumer via social media;
relaying each of the consumer requests to the group of providers;
storing the name of a provider accepting the consumer request to the consumer;
facilitating real-time textual communication between the consumer and the provider picked by the consumer, wherein the real-time textual communication further comprises:
displaying a history of textual communications between the consumer and the provider;
accepting an item request by a consumer, the item request added to a computer-readable file with the consumer request in an RDBMS;
relaying the name of the item request to the provider via a WAN;
relaying the media to the consumer;
storing and forwarding a price set by the provider for the item request; and
accepting an uploaded Boolean value from the consumer representing acceptance or rejection of the price set by the provider;
accepting a delivery confirmation from the consumer in response to the provider delivering the consumer good; and
remunerating the provider picked by the consumer in accordance with a predetermined remuneration criteria.

18. The computer program product of claim 19, wherein facilitating real-time textual communication further comprises:
receiving into computer-readable memory, via the WAN, from the provider media comprising an image of a consumer good identified in the item request in response to a consumer requesting the media; and
relaying the media to the consumer.

19. The computer program product of claim 19, further comprising:
adding a flat rate tip value to the price of the sum of the consumer good and one or more item requests, the flat rate tip value predetermined by a third-party without input from the consumer and provider;
preventing the consumer and provider from augmenting or reducing a remuneration total predetermined by the remuneration criteria.

20. A system for brokering a real-world transaction, the system comprising:
a plurality of processors;
persistent computer-readable memory;
a location module configured to determine a geolocation of a plurality of providers expressed in GPS coordinates and one or more of the following:
GPS coordinates of a consumer expressed in standard global positioning system (GPS) coordinates;
a physical address of a consumer expressed as a mailing address in a character string;
a geocoding module configured to:
convert GPS coordinates to a mailing address in a character string; and
convert a character string comprising as mailing address to GPS coordinates;
a storer module configured to store an item request originating with a consumer, the item request comprising a name of a consumer good, a name of a shopping location, and a delivery location specified by the consumer;
a provider incorporator module configured to identify a group of consumers within a polygonal area surrounding a dynamic location of a provider, updated asynchronously, who are available for purchasing a consumer good;
a request creator module configured to store and relay each of the consumer requests to the group of providers;
a facilitator module configured to facilitate real-time textual communication exclusively between a consumer and a provider; and
a determiner module configured to store a Boolean delivery confirmation value in computer-readable memory from the consumer in response to the provider delivering the consumer good.

21. The system of claim 24, further comprising an eliminator module configured to eliminate a provider originating a consumer request, wherein the consumer selection criteria comprises a Boolean value evaluating as true in response to previous occurrence of one or more of the following events:
recent consumer complaints;
non-delivery of a consumer product in an earlier item request originating with another consumer;
late delivery of a consumer product in an earlier item request originating with another consumer;
non-delivery of a consumer product in an earlier item request originating with the consumer;
late delivery of a consumer product in an earlier item request originating with the consumer;
non-delivery of a consumer product in an earlier item request originating with another consumer; and
damage to a consumer product in an earlier item request.

22. The system of claim 24, wherein a consumer preference criteria is satisfied with respect to providers being located by the location module within a predetermined geographic radius of the consumer.

23. The system of claim 24, further comprising a matcher module configured to match an item request with a provider having a highest match satisfaction value with a match selection criterion, the match satisfaction value being derived as a function of one or more of the following values:
a value determined by totaling the number of social contact the consumer and a provider share in common;
a provider determined by the location module to be within a shortest predetermined distance from the consumer;
a total number of previous confirmed deliveries of a provider; and
a provider's positive ratings stored in computer-readable memory.

24. The system of claim 24, further comprising a matcher module configured to match the consumer with a provider, the matcher module comprising a plurality of submodules, the submodules comprising:
a retailer module configured to store in computer-readable memory names and addresses of a plurality of preferred retailers, the names and addresses of the plurality of preferred retailers identified by the consumer;
a distance module configured to accept and store in computer-readable memory one of:
a radius value, the radius value comprising a radius from a retail location within which a provider will deliver a consumer product; and
a time maximum, the time maximum comprising a maximum delivery time from a retail location to the consumer within which a provider will deliver a consumer product;
a determiner module configured to do one or more of the following:
determine a distance between the consumer and the retail location by passing parameters to an API, the parameters comprising: geolocation information of the consumer and the address of a preferred retailer; and
determine a travel time between the consumer and the retail location by passing parameters to an API, the parameters comprising: geolocation information of the consumer and the address of a preferred retailer;
a notification module configured to relay the name of the provider to the consumer in response to determining one or more of: the distance is less than the radius value and the travel time is less than the time maximum.
